(19) United States
(12) Patent Application Publication
(10) Pub. No.: US 2025/0220409 A1
(43) Pub. Date: Jul. 3, 2025

(54) ELECTRONIC DEVICE AND NAN COMMUNICATION METHOD

(71) Applicant: Samsung Electronics Co., Ltd., Suwon-si (KR)

(72) Inventors: Junsung KIM, Suwon-si (KR); Buseop JUNG, Suwon-si (KR); Soonho LEE, Suwon-si (KR)

(21) Appl. No.: 19/082,697

(22) Filed: Mar. 18, 2025

Related U.S. Application Data
(63) Continuation of application No. PCT/KR2023/011498, filed on Aug. 4, 2023.

(30) Foreign Application Priority Data
Sep. 23, 2022 (KR) 10-2022-0121009
Nov. 21, 2022 (KR) 10-2022-0156115

(51) Int. Cl. H04W 8/00; H04W 4/80; H04W 28/18; H04W 84/18

(52) U.S. Cl. CPC H04W 8/005; H04W 28/18; H04W 4/80; H04W 84/18

(57) ABSTRACT

An electronic device may include one or more wireless communication modules including: a first communication module supporting an NAN protocol; and a second communication module using a frequency band different from that of the first communication module. The electronic device may comprise one or more processors, including processing circuitry, operatively connected to the one or more wireless communication modules. The electronic device may comprise a memory configured to store instructions. The instructions are executed individually and/or collectively, by the one or more processors, to cause the electronic device to transmit or receive, via the first communication module, data to or from an external electronic device included in a NAN cluster along with the electronic device. The instructions are executed individually and/or collectively, by the one or more processors, to cause the electronic device to transmit associated information about the NAN cluster to the external electronic device after the data transmission and reception operation supported via the first communication module ends. The instructions are executed individually and/or collectively, by the one or more processors, to cause the electronic device to hand off the associated information about the NAN cluster from the first communication module to the second communication module. The instructions are executed individually and/or collectively, by the one or more processors, to cause the electronic device to maintain the NAN cluster on the basis of the associated information about the NAN cluster via the second communication module. Various other embodiments may be possible.

### CROSS-REFERENCE TO RELATED APPLICATIONS

This application is a continuation application of International Application No. PCT/KR2023/011498 designating the United States, filed on Aug. 4, 2023, in the Korean Intellectual Property Receiving Office and claiming priority to Korean Patent Application No. 10-2022-0121009, filed on Sep. 23, 2022, and Korean Patent Application No. 10-2022-0156115, filed on Nov. 21, 2022, the disclosures of which are all hereby incorporated by reference herein in their entireties.

### BACKGROUND

### Technical Field

Certain example embodiments may relate to an electronic device and/or a neighbor awareness networking (NAN) communication method.

### Background Art

Recently, various proximity services with low-power discovery technology using short-range communication technology have been actively developed. For example, a proximity communication service for nearby electronic devices to rapidly exchange data through a proximity network has been developed.

In recent wireless fidelity (Wi-Fi) standards, low-power discovery technology called neighbor awareness networking (NAN) is being developed, and short-range proximity services using NAN are being actively developed.

### SUMMARY

According to an example embodiment, an electronic device may include one or more wireless communication modules including a first communication module, comprising communication circuitry, configure for supporting a neighbor awareness networking (NAN) protocol and a second communication module, comprising communication circuitry, configured for supporting a high efficiency low power (HaLow) protocol. The electronic device may include one or more processors, comprising processing circuitry, operatively connected to the one or more wireless communication modules. The electronic device may include a memory electrically connected to the one or more processors and configured to store instructions executable by the one or more processors. The electronic device, when the instructions are executed by the one or more processors individually and/or collectively, causes the one or more processors to individually and/or collectively perform a plurality of operations through the one or more wireless communication modules. The plurality of operations may include an operation of transmitting and receiving data to and from an external electronic device included in both a NAN cluster and the electronic device through the first communication module. The plurality of operations may include an operation of transmitting the association information of the first NAN cluster to the external electronic device after terminating the operation of transmitting and receiving data, supported through the first communication module. The plurality of operations may include an operation of handing off the association information of the NAN cluster from the first communication module to the second communication module. The plurality of operations may include an operation of maintaining the NAN cluster based on the association information of the NAN cluster through the second communication module.

According to an example embodiment, an electronic device may include one or more wireless communication modules including a first communication module supporting a NAN protocol and a second communication module supporting a HaLow protocol. The electronic device may include one or more processors, comprising processing circuitry, operatively connected to the one or more wireless communication modules. The electronic device may include a memory electrically connected to the one or more processors and configured to store instructions executable by the one or more processors. The electronic device, when the instructions are executed by the one or more processors, causes the one or more processors to perform a plurality of operations through the one or more wireless communication modules. The plurality of operations may include an operation of transmitting and receiving data to and from an external electronic device included in both a first NAN cluster and the electronic device through the first communication module. The plurality of operations may include an operation of transmitting the association information of the first NAN cluster to the external electronic device after terminating the operation of transmitting and receiving data, supported through the first communication module. The plurality of operations may include an operation of handing off the association information of the first NAN cluster from the first communication module to the second communication module. The plurality of operations may include an operation of forming a second NAN cluster including the electronic device and the external electronic device based on the association information of the first NAN cluster through the second communication module.

According to an example embodiment, an electronic device may include one or more wireless communication modules including a first communication module supporting a NAN protocol and a second communication module supporting a HaLow protocol. The electronic device may include one or more processors, comprising processing circuitry, operatively connected to the one or more wireless communication modules. The electronic device may include a memory electrically connected to the one or more processors and configured to store instructions executable by the one or more processors. The electronic device, when the instructions are executed by the one or more processors, causes the one or more processors to perform a plurality of operations through the one or more wireless communication modules. The plurality of operations may include an operation of transmitting and receiving data to and from an external electronic device included in both a NAN cluster and the electronic device through the first communication module. The plurality of operations may include an operation of handing off the association information of the NAN cluster from the first communication module to the second communication module after terminating the operation of transmitting and receiving data, supported through the first communication module.

The plurality of operations may include an operation of transmitting the association information of the NAN cluster and the association information of the HaLow protocol to the external electronic device through the second communication module. The plurality of operations may include an operation of performing HaLow setup with the external electronic device, based on the association information of the HaLow protocol, through the second communication module. The plurality of operations may include an operation of maintaining the association information of the NAN cluster by transmitting a HaLow beacon including the association information of the NAN cluster to the external electronic device through the second communication module.

### BRIEF DESCRIPTION OF DRAWINGS

FIG. 1 is a diagram illustrating a neighbor awareness networking (NAN) cluster according to an example embodiment.

FIG. 2 is a diagram illustrating NAN protocol-based communication according to an example embodiment.

FIG. 3 is a diagram illustrating communication between electronic devices in a NAN cluster according to an example embodiment.

FIG. 4 is a diagram schematically illustrating a NAN security publish/subscribe message flow according to an example embodiment.

FIG. 5 is a diagram illustrating the role and state transitions of electronic devices included in a NAN cluster according to an example embodiment.

FIGS. 6A and 6B are example diagrams each illustrating the discovery beacon transmission of a master device.

FIGS. 7A and 7B are diagrams each illustrating a time synchronization function (TSF) used for time synchronization in the NAN cluster according to an example embodiment.

FIG. 8 is a diagram illustrating an example operation of forming a NAN cluster.

FIG. 9 is a diagram illustrating an example NAN data link schedule.

FIGS. 10A and 10B are example diagrams each illustrating a high efficiency low power (HaLow) protocol.

FIGS. 11A and 11B are example diagrams each illustrating a frame used in a HaLow protocol.

FIGS. 12A and 12B are example diagrams each illustrating a protocol associated with a HaLow protocol.

FIG. 13 is a schematic block diagram illustrating an electronic device according to an example embodiment.

FIG. 14 is a diagram illustrating information exchange performed by an example electronic device and an example external electronic device.

FIGS. 15A to 15C are diagrams each illustrating an operating method of the electronic device according to an embodiment.

FIG. 16 is a diagram illustrating an operating method of the electronic device according to an example embodiment.

FIG. 17 is a diagram illustrating an operating method of the electronic device according to an example embodiment.

FIG. 18 is a flowchart illustrating an operating method of the electronic device according to an example embodiment.

FIG. 19 is a block diagram illustrating an electronic device in a network environment according to an example embodiment.

### DETAILED DESCRIPTION

Hereinafter, embodiments are described in detail with reference to the accompanying drawings. When describing the embodiments with reference to the accompanying drawings, like reference numerals refer to like elements, and a repeated description related thereto is omitted.

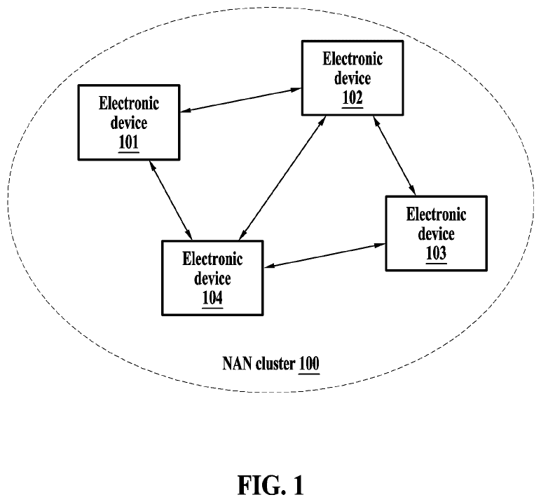

FIG. 1 is a diagram illustrating a neighbor awareness networking (NAN) cluster according to an embodiment.

Referring to FIG. 1, according to an embodiment, a NAN cluster 100 may include one or more electronic devices (e.g., an electronic device 101, an electronic device 102, an electronic device 103, and/or an electronic device 104 of FIG. 1). In the NAN cluster 100, the electronic devices 101, 102, 103, and 104 may communicate with one another through NAN. The NAN cluster 100 may refer to a set of one or more electronic devices 101, 102, 103, and 104 forming a proximity network such that the electronic devices 101, 102, 103, and 104 may transmit and receive data to and from one another.

According to an embodiment, the electronic devices 101, 102, 103, and 104 may be devices that support NAN, which is low-power discovery technology, and may be referred to as NAN devices (or NAN terminals). In addition, the electronic device 101, 102, 103, or 104 may operate in a frequency band of 2.4 GHz, 5 GHZ, and/or 6 GHz and may exchange signals based on the Institute of Electrical and Electronic Engineers (IEEE) 802.11 protocol (e.g., 802.11 a/b/g/n/ac/ax/be). The electronic devices 101, 102, 103, and 104 may exchange signals in a unicast, broadcast, and/or multicast manner.

According to an embodiment, the electronic devices 101, 102, 103, and 104 may form one NAN cluster 100 by transmitting and receiving beacons (e.g., discovery beacons). The electronic devices 101, 102, 103, and 104 in the NAN cluster 100 may be those on which time synchronization and channel synchronization have been performed.

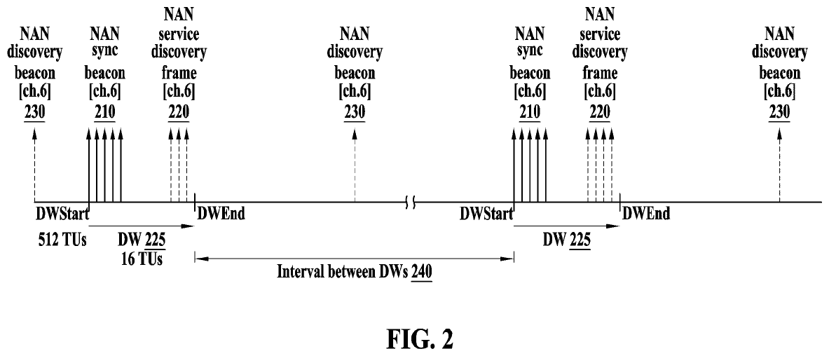

According to an embodiment, the discovery beacon (e.g., discovery beacons 230 of FIG. 2) may be beacon signals for discovering an electronic device capable of forming a cluster (e.g., the NAN cluster 100) for a proximity network. In addition, the discovery beacons may be transmitted signals such that another electronic device (not shown) failing to join the NAN cluster 100 may discover the NAN cluster 100. The discovery beacons may be signals for informing the existence of the NAN cluster 100. An electronic device (not shown) not joining the NAN cluster 100 may receive discovery beacons through passive scanning and may discover and join the NAN cluster 100.

According to an embodiment, a discovery beacon may include information necessary for synchronization with the NAN cluster 100. For example, the discovery beacon may include a frame control (FC) field indicating a function of a signal (e.g., a beacon), a broadcast address, a media access control (MAC) address of a transmission electronic device, a cluster identifier (ID), a sequence control field, a time stamp for a beacon frame, a beacon interval indicating a transmission interval of the discovery beacon, and/or capability information on the transmission electronic device. In addition, the discovery beacon may further include an information element related to at least one proximity network (or cluster) (e.g., the NAN cluster 100). Proximity network-related information may be referred to as “attribute information”.

According to an embodiment, the electronic devices 101, 102, 103, and 104 may transmit and receive signals (e.g., synchronization beacons (e.g., synchronization beacons 210 of FIG. 2), service discovery frames (SDFs) (e.g., SDFs 220 of FIG. 2), and/or NAN action frames (NAFs)) within a synchronized time duration (e.g., a discovery window (DW)). For example, the electronic devices 101, 102, 103, and 104 may have time clocks synchronized with one another and may exchange synchronization beacons, SDFs, and/or NAFs with one another within a synchronized DW at the same time.

According to an embodiment, the synchronization beacons (e.g., the synchronization beacons 210 of FIG. 2) may be signals for maintaining synchronization between the synchronized electronic devices 101, 102, 103, and 104 in the NAN cluster 100. The synchronization beacons may be periodically transmitted and received in each DW to continuously maintain the time synchronization and channel synchronization of the electronic devices 101, 102, 103, and 104 in the NAN cluster 100. The synchronization beacons may be transmitted by a designated electronic device among the electronic devices 101, 102, 103, and 104 in the NAN cluster 100. An electronic device that transmits synchronization beacons may include or be referred to as an anchor master device, a master device, or a non-master sync device for example as defined in the NAN standard.

According to an embodiment, the synchronization beacons may include information necessary for the synchronization of the electronic devices 101, 102, 103, and 104 in the NAN cluster 100. For example, the synchronization beacon may include at least one of an FC field indicating a function of a signal (e.g., a beacon), a broadcast address, a MAC address of a transmission electronic device, a cluster ID, a sequence control field, a time stamp for a beacon frame, a beacon interval indicating an interval between start points of DWs, and capability information on the transmission electronic device. The synchronization beacon may further include an information element related to at least one proximity network (or cluster) (e.g., the NAN cluster 100). Proximity network-related information may include content for a service provided through the proximity network.

According to an embodiment, SDFs (e.g., the SDFs 220 of FIG. 2) may be signals to exchange data through a proximity network (or cluster) (e.g., the NAN cluster 100). The SDF may indicate a vendor-specific public action frame and may include various fields. For example, the SDF may include a category or an action field and may further include at least one piece of proximity network (e.g., the NAN cluster 100)-related information

According to an embodiment, the electronic devices 101, 102, 103, and 104 included in the NAN cluster 100 may transmit and receive NAFs within a DW. For example, the NAFs may include information related to a NAN data path (NDP) setup for performing data communication in a DW, information for schedule updates, and/or information for performing NAN ranging (e.g., fine timing measurement (FTM) NAN ranging). The NAFs may be intended to control a schedule of radio resources for the coexistence of a NAN operation and a non-NAN operation (e.g., wireless fidelity (Wi-Fi)

Direct, mesh, independent basic service set (IBSS), wireless local area network (WLAN), Bluetooth™, or near-field communication (NFC)). The NAF may include time and channel information available for NAN communication.

FIG. 2 is a diagram illustrating NAN protocol-based communication according to an embodiment.

Referring to FIG. 2, according to an embodiment, signals transmitted during an interval 200 within a DW and signals transmitted during an interval 240 outside the DW may be identified. Electronic devices (e.g., the electronic devices 101, 102, 103, and/or 104 of FIG. 1) included in a NAN cluster (e.g., the NAN cluster 100 of FIG. 1) may perform discovery, synchronization, and/or data exchange operations according to the NAN protocol. In FIG. 2, it may be assumed that communication is performed through a channel (e.g., Channel 6 (Ch6)) designated based on the NAN standard.

According to an embodiment, at least one (e.g., a master device) of the electronic devices 101, 102, 103, and 104 may broadcast the discovery beacons 230 in every preset first cycle (e.g., about 100 milliseconds (ms)). At least one (e.g., a non-master device) of the electronic devices 101, 102, 103, and 104 may perform scanning in every preset second cycle (e.g., about 10 ms) and receive the discovery beacons 230 broadcasted from the electronic device (e.g., the master device). The electronic devices 101, 102, 103, and 104 may recognize another nearby electronic device based on the discovery beacon 230. The electronic devices 101, 102, 103, and 104 may perform time synchronization and channel synchronization with the recognized electronic device.

According to an embodiment, time synchronization and channel synchronization may be performed based on the time and channel of an electronic device having the highest master rank in the NAN cluster 100. The electronic devices 101, 102, 103, and 104 may mutually exchange signals related to master rank information indicating a preference for operating as an anchor master. The electronic device having the highest master rank may be determined to be an anchor master device (or a master device). The master device may refer to an electronic device that is a standard of the time synchronization and channel synchronization of the electronic devices 101, 102, 103, and 104 in the NAN cluster 100. The master device may vary depending on the master ranks of electronic devices.

According to an embodiment, the master device may transmit the discovery beacons 230 including information, such as a cluster ID (e.g., the ID of the NAN cluster 100), during an interval 240 between intervals (e.g., DWs 225), other than the DW 225. The discovery beacons 230 may be intended to inform the existence of the NAN cluster 100. The master device may transmit the discovery beacons 230 such that another electronic device failing to join the NAN cluster 100 may discover the NAN cluster 100.

According to an embodiment, the DW 225 may be a duration in which the electronic devices 101, 102, 103, and 104 are activated from a sleep state, which corresponds to a power-saving mode, to a wake-up state to exchange data with one another. For example, the DW 225 may be divided into time units (TUs) in milliseconds. The DW 225 for transmitting and receiving the synchronization beacons 210 and the SDFs 220 may occupy 16 TUs. The DW 225 may have a cycle (or an interval) that repeats with 512 TUs.

According to an embodiment, the electronic devices 101, 102, 103, and 104 may operate in an active state during the DW 225 and may operate in a low-power state (e.g., a sleep state) during the remaining interval 240 other than the DW 225. The DW 225 may be a time (e.g., millisecond) during which the electronic devices 101, 102, 103, and 104 are in an active state (or a wake-up state). During the DW 225, an electronic device in the active state may consume a lot of currents. During the interval 240, other than the DW 225, an electronic device in the low-power state may remain in the sleep state. The electronic devices 101, 102, 103, and 104 may perform low-power discovery. The electronic devices 101, 102, 103, and 104 may be simultaneously activated at the start time (e.g., DW start) of the DW 225, which is time-synchronized, and may simultaneously switch to the sleep state at the end time (e.g., DW end) of the DW 225.

According to an embodiment, at least one (e.g., a master device or a non-master sync device) of the electronic devices 101, 102, 103, and 104 included in the NAN cluster 100 may transmit the synchronization beacons 210 within the DW 225 (e.g., the synchronized DW). The electronic devices 101, 102, 103, and 104 may transmit the SDFs 220 within the DW 225. The electronic device 101, 102, 103, or 104 may transmit the synchronization beacon 210 and the SDF 220 on a contention basis. The transmission priority of the synchronization beacons 210 may be higher than that of the SDFs 220.

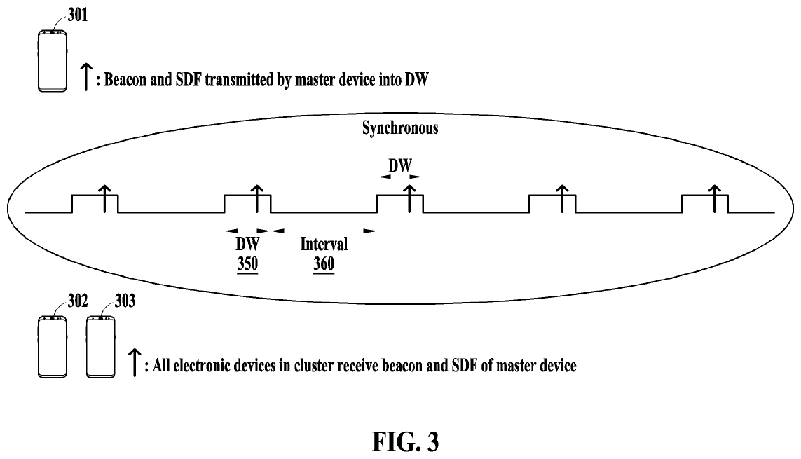

FIG. 3 is a diagram illustrating communication between electronic devices in a NAN cluster according to an embodiment.

Referring to FIG. 3, according to an embodiment, an operation in which electronic devices 301, 302, and 303 form one cluster (e.g., the NAN cluster 100 of FIG. 1) and communicate with one another through wireless short-range communication technology is shown. The electronic devices 301, 302, and 303 of FIG. 3 may be NAN devices like the electronic devices 101, 102, 103, and 104 of FIG. 1. The electronic device 301 may be a master device. The electronic devices 302 and 303 may be non-master devices.

According to an embodiment, the electronic device 301 may transmit beacons (e.g., synchronization beacons), SDFs, and/or NAFs within a DW 350. The electronic device 301 may broadcast the beacons, SDFs, or NAFs within the DW 350 that repeats at every preset interval (or cycle) (e.g., an interval 360). The electronic devices 302 and 303 may receive the beacons, SDFs, and/or NAFs transmitted by the electronic device 301. Each of the electronic devices 302 and 303 may receive the beacons, SDFs, and/or NAFs broadcasted from the electronic device 301 in every DW 350.

According to an embodiment, the beacons transmitted in the DW 350 may be synchronization beacons. The synchronization beacons may include information for maintaining the synchronization between the electronic devices 301, 302, and 303. The electronic devices 301, 302, and 303 may be synchronized with the time clock of the master device 301 and activated at the same time (e.g., in the DW 350). The electronic devices 302 and 303 may remain in a sleep state for a duration other than the DW 350 (e.g., the interval 360) to reduce current consumption.

According to an embodiment, the NAFs transmitted in the DW 350 may include information related to NDP setup for performing data communication in a DW, information for schedule update, and/or information for performing NAN ranging (e.g., FTM NAN ranging). Hereinafter, an NDP setup flow is described.

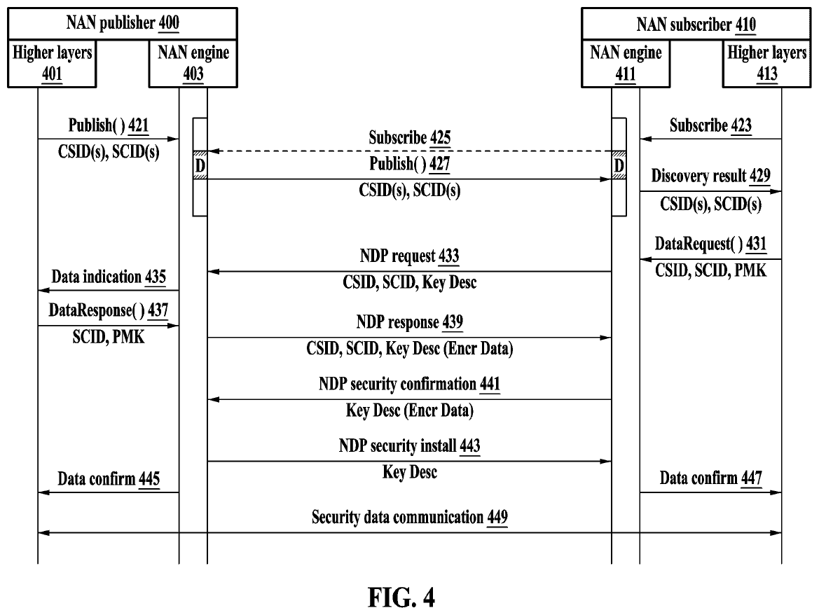

FIG. 4 is a diagram schematically illustrating a NAN security publish/subscribe message flow according to an embodiment.

Referring to FIG. 4, according to an embodiment, a NAN publisher 400 may include higher layers 401 and a NAN engine 403. A NAN subscriber 410 may include a NAN engine 411 and higher layers 413. Each of the NAN engine 403 and the NAN engine 411 may include a NAN discovery engine, ranging, a NAN data engine, a NAN scheduler, and/or a NAN MAC layer. A device 400 or 410 of FIG. 4 may be a NAN device like the electronic devices 101, 102, 103, and 104 of FIG. 1 and the electronic devices 301, 302, and 303 of FIG. 3.

Operations 421 to 449 may be performed sequentially but not necessarily. For example, the order of operations 421 to 449 may be changed, and at least two operations may be performed in parallel.

In operation 421, the higher layers 401 of the NAN publisher 400 may transmit a publish message advertising at least one of at least one cipher suite identifier (CSID) or at least one useful security context identifier (SCID) supported to the NAN engine 403 of the NAN publisher 400. The useful SCID may include an SCID.

In operation 423, the higher layers 413 of the NAN subscriber 410 may transmit a subscribe message to the NAN engine 411 to actively search for the usefulness of a designated service.

In operation 425, the NAN engine 411 of the NAN subscriber 410 may transmit a subscribe message in a DW. In operation 427, the NAN engine 403 of the NAN publisher 400 may transmit the publish message in the DW.

In operation 429, the NAN engine 411 of the NAN subscriber 410 may generate a discovery request message based on the received publish message and transmit the generated discovery request message to the higher layers 413 of the NAN subscriber 410. The discovery request message may include, for example, at least one CSID or at least one SCID included in the publish message. The higher layers 413 of the NAN subscriber 410 may select a CSID and an SCID suitable for performing NDP negotiation and establishing a NAN pairwise security association (SA).

In operation 431, the higher layers 413 of the NAN subscriber 410 may transmit a data request message including the CSID, the SCID, and a pairwise master key (PMK) to the NAN engine 411 of the NAN subscriber 410. The message flow used together with NCS-SK to establish the NAN pairwise SA may have a similar form to the robust security network association (RSNA) 4-way handshake process for example as defined in the IEEE 802.11 standard. A process that may correspond to the RSNA 4-way handshake process may include operation 433 of transmitting an NDP request message, operation 439 of transmitting an NDP response message, operation 441 of transmitting an NDP security confirmation message, and operation 443 of transmitting an NDP security install message.

In operation 433, the NAN engine 411 of the NAN subscriber 410 may transmit an NDP request message including the CSID, the SCID, and a key descriptor (Key Desc) to the NAN publisher 400.

In operation 435, the NAN engine 403 of the NAN publisher 400 may transmit a data indication message to the higher layers 401 of the NAN publisher 400 upon receiving the NDP request message. In operation 437, the higher layers 401 of the NAN publisher 400 receiving the data indication message from the NAN engine 403 of the NAN publisher 400 may transmit a data response message that is a response message to the data indication message to the NAN engine 403 of the NAN publisher 400. The data response message of operation 437 may include the SCID and the PMK.

In operation 439, the NAN engine 403 of the NAN publisher 400 receiving the data response message from the higher layers 401 of the NAN publisher 400 may transmit an NDP response message that is a response message to the NDP request message to the NAN subscriber 410 (e.g., the NAN engine 411 of the NAN subscriber 410). The NDP response message may include the CSID, the SCID, and Key Desc (Encr Data).

In operation 441, the NAN engine 411 of the NAN subscriber 410 receiving the

NDP response message may transmit an NDP security confirmation message to the NAN publisher 400 (e.g., the NAN engine 403 of the NAN publisher 400). The NDP security confirmation message may include Key Desc (Encr Data).

In operation 443, the NAN engine 403 of the NAN publisher 400 receiving the NDP security confirmation message may transmit an NDP security install message to the NAN subscriber 410 (e.g., the NAN engine 411 of the NAN subscriber 410). The NDP security install message may include Key Desc.

In operation 445, the NAN engine 403 of the NAN publisher 400 transmitting the NDP security installation message may transmit a data confirm message to the higher layers 401 of the NAN publisher 400. In operation 447, the NAN engine 411 of the NAN subscriber 410 receiving the NDP security installation message may transmit a data confirm message to the higher layers 413 of the NAN subscriber 410.

In operation 449, secure data communication may be performed between the NAN publisher 400 and the NAN subscriber 410. The SCID attribute field for the SCID used in the NAN security publish/subscribe message flow of FIG. 4 may be represented as shown in Table 1 below.

TABLE 1

| | Size | | |
|---|---|---|---|
| Field | (octets) | Value | Description |
| Security | 2 | Variable | Identifies the length of the |
| Context | | | Security Context Identifier |
| Identifier | | | field |
| Type | | | |
| Length | | | |
| Security | 1 | Variable | The type of Security Context Identifier. |
| Context | | | 0 - Reserved |
| Identifier | | | 1 - PMKID |
| Type | | | 2-255: Reserved |
| Publish ID | 1 | Variable | Identifies the Publish Service Instance |
| Security | Variable | Variable | Identifies the Security Context. For NAN Shared Key |
| Context | | | Cipher Suite, this field contains the 16 octet PMKID |
| Identifier | | | identifying the PMK used for setting up the Secure |
| | | | Data Path. |

In Table 1, a Security Context Identifier Type Length field may be implemented with “2” octets and may be used to identify the length of the SCID field. In Table 1, a Security Context Identifier Type field may be implemented with “1” octet and may indicate the type of SCID. For example, when the field value of the Security Context Identifier Type field is “1”, the Security Context Identifier Type field may indicate a pairwise master key identifier (PMKID). In Table 1, the Publish ID field may be implemented with “1” octet and may be used to identify a publish service instance. The Security Context Identifier field may be used to identify a security context. For NCS-SK, the Security Context Identifier field may include a “16” octet-PMKID identifying protected management frames (PMFs) used for setting up a secure data path.

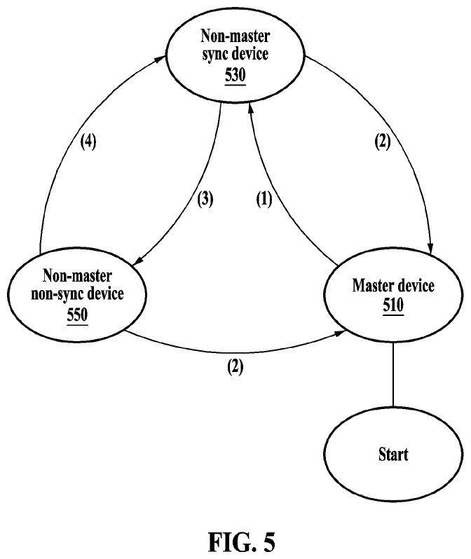

FIG. 5 is a diagram illustrating the role and state transitions of electronic devices included in a NAN cluster according to an embodiment.

Referring to FIG. 5, according to an embodiment, a cluster (e.g., the NAN cluster 100 of FIG. 1) may include a master device 510, a non-master sync device 530, and a non-master non-sync device 550 performing respective roles. The roles (or states) of the electronic devices 510, 530, and 550 shown in FIG. 5 may be the roles (or states) of NAN devices (e.g., the electronic devices 101, 102, 103, and 104 of FIG. 1, the electronic devices 301, 302, and 303 of FIG. 3, or the devices 400 and 410 of FIG. 4).

According to an embodiment, the roles (or states) of the electronic devices 510, 530, and 550 may be transitioned based on whether a condition according to the NAN protocol is satisfied. For example, the NAN protocol defines conditions (e.g., RSSIs and/or master ranks) for transitions (e.g., (1), (2), (3), and (4)) of the states of electronic devices included in a cluster. However, not all the conditions in the NAN protocol are described in detail but are described briefly hereinafter.

According to an embodiment, the roles of the electronic devices included in the NAN cluster may be determined based on the master ranks. For example, among the electronic devices included in the NAN cluster, an electronic device having the greatest master rank value may become the master device 510. A master rank may include factors, such as a master preference (e.g., a value from between “0” and “128”), a random factor (e.g., a value between “0” and “255”), and/or a media access control (MAC) address (e.g., an interface address of a NAN electronic device). A master rank value may be calculated through Equation 1.

$$[ Equation 1 ]$$

$$Master Rank = Master Preference * {2}^{56} + Random Factor * {2}^{48} + MAC [ 5 ] * {2}^{40} + … + MAC [ 0 ]$$

According to the NAN standard, the master rank according to the sum of the above factors may be calculated for each of the electronic devices synchronized with the cluster, and an electronic device having a relatively high master rank may have a role (or a state) of the master device 510.

According to an embodiment, whether the electronic devices synchronized with the cluster are capable of transmitting synchronization beacons (e.g., the synchronization beacons 210 of FIG. 2) and discovery beacons (e.g., the discovery beacons 230 of FIG. 2) may be determined according to the roles (or states). For example, the synchronization beacons may be transmitted by the master device 510 and the non-master sync device 530, and the discovery beacons may be transmitted by the master device 510. Whether the electronic devices are capable of transmitting discovery beacon frames and/or synchronization beacon frames may be determined according to their respective roles and states, which may be shown in Table 2 below.

TABLE 2

| Role and State | Discovery Beacon | Synchronization Beacon |
|---|---|---|
| Master | Transmittable | Transmittable |
| Non-Master Sync | Not transmittable | Transmittable |
| Non-Master Non-Sync | Not transmittable | Not transmittable |

According to an embodiment, the size (or level) of a cluster class may be determined based on a master rank. For example, when the first master rank of a first master device synchronized with a first cluster is relatively high (or greater) compared to the second master rank of a second master device synchronized with a second cluster, the class of the first cluster may be understood as being relatively high (or greater) compared to the class of the second cluster. The class of the cluster may be determined by a master rank calculated by using only a master preference among the factors of the master rank. If the master rank of the first cluster and the master rank of the second cluster have the same value, the class relationship between the first cluster and the second cluster may be determined by a master rank calculated by using the remaining factors (e.g., a random factor and/or a MAC address) of the master rank.

According to an embodiment, the class of the cluster may be determined based on the number of electronic devices synchronized with the cluster, the number of proximity services provided by the cluster, and/or the security level of the cluster, regardless of the master rank. For example, if the number of electronic devices synchronized with the cluster is large, the number of proximity services provided by the cluster is large, and/or the security level of the cluster is high (or large), the cluster may be determined to have a high (or large) class.

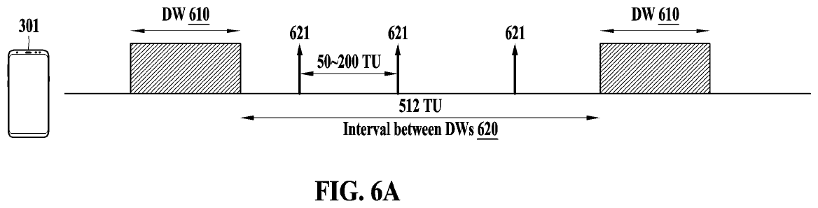

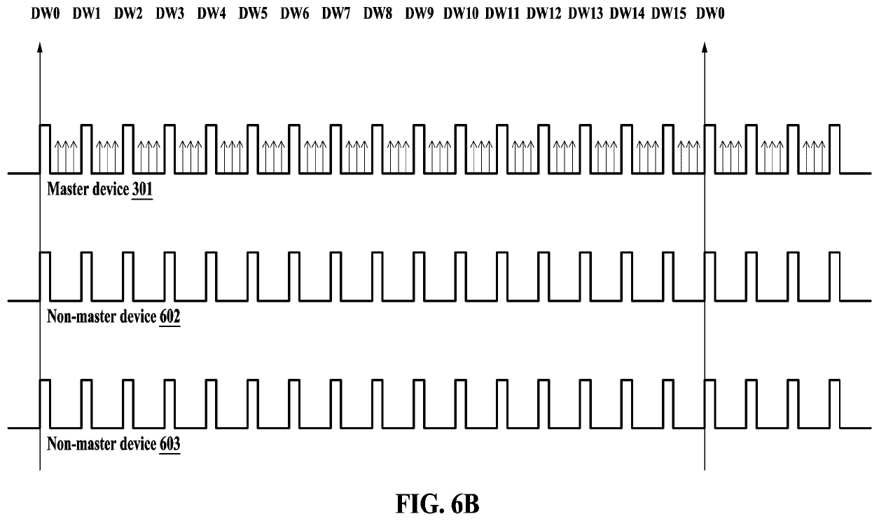

FIGS. 6A and 6B are diagrams each illustrating the discovery beacon transmission of a master device.

According to an embodiment, devices 301, 602, and 603 shown in FIGS. 6A and 6B may be NAN devices like the electronic devices 101, 102, 103, and 104 of FIG. 1, the electronic devices 301, 302, and 303 of FIG. 3, and the devices 400 and 410 of FIG. 4. A NAN device may be a device supporting NAN, which is low-power discovery technology. The master device 301 and the non-master devices 602 and 603 may be synchronized with one NAN cluster (e.g., the NAN cluster 100 of FIG. 1).

Referring to FIG. 6A, according to an embodiment, the master device 301 may periodically transmit discovery beacons 621 for an interval between DWs 620. The transmission cycle of the discovery beacons 621 may be 50 to 200 TUs. The interval between DWs 620 may be 512 TUs, and the master device 301 may transmit the discovery beacons 621 2 to 10 times for the interval between DWs 620. As described above with reference to FIG. 2, the NAN protocol may cause a NAN device to operate in an active state during a DW 610 and operate in a low-power state (e.g., a sleep state) for the interval between DWs 620. However, the master device 301 may need to be activated 2 to 10 times for the interval between DWs 620 for periodically transmitting the discovery beacons 621. The master device 301 may consume greater current compared to the non-master devices 602 and 603. Referring to FIG. 6B, according to an embodiment, DWs (e.g., DW0 to DW15) and discovery beacons transmitted by the master device 301 (e.g., the discovery beacons 621 transmitted by the master device 301 for the interval between DWs 620) are shown. The non-master devices 602 and 603 may be activated only in a portion of the DWs (e.g., DW0 to DW15). However, the master device 301 may be activated during all DWs. The master device 301 may need to be activated during all DWs and may need to be activated intermittently even for an interval between DWs. The master device 301 may consume greater current compared to the non-master devices 602 and 603.

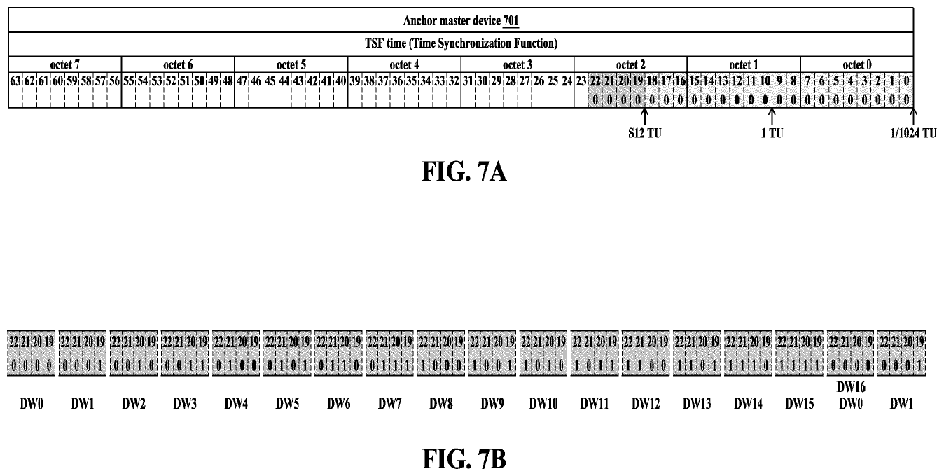

FIGS. 7A and 7B are diagrams each illustrating a time synchronization function (TSF) used for time synchronization in a NAN cluster according to an embodiment.

According to an embodiment, NAN devices (e.g., the electronic devices 101, 102, 103, and 104 of FIG. 1, the electronic devices 301, 302, and 303 of FIG. 3, the electronic devices 400 and 410 of FIG. 4, and the devices 602 and 603 of FIG. 6) may each operate a TSF timer (e.g., a local TSF timer). The TSF timer may correspond to a clock. As time passes, TSF timer information (e.g., a 64-bit TSF timer value) may change constantly.

According to an embodiment, the lower 23 bits (e.g., 0 bits to 22 bits) of the 64-bit TSF timer information may be used for time synchronization. 1/1024 TUs to 512 TUs may be expressed by using 0 bits to 18 bits of the TSF timer information. The DWs (e.g., DW0 to DW15) may be expressed by using 19 bits to 22 bits of the TSF timer information. When NAN devices and an anchor master device 701 are synchronized with the same NAN cluster, the NAN devices may be time-synchronized based on TSF timer information of the anchor master device 701.

The TSF timer information of the anchor master device 701 shown in FIG. 7A may be TSF timer information at a start time of DW1. A total of 16 DWs (e.g., DW0 to DW15) may be repeated in the NAN protocol. Pieces (e.g., 19 bits to 22 bits of the timer information) of the TSF timer information shown in FIG. 7B may correspond to the DWs (e.g., DW0 to DW15), respectively.

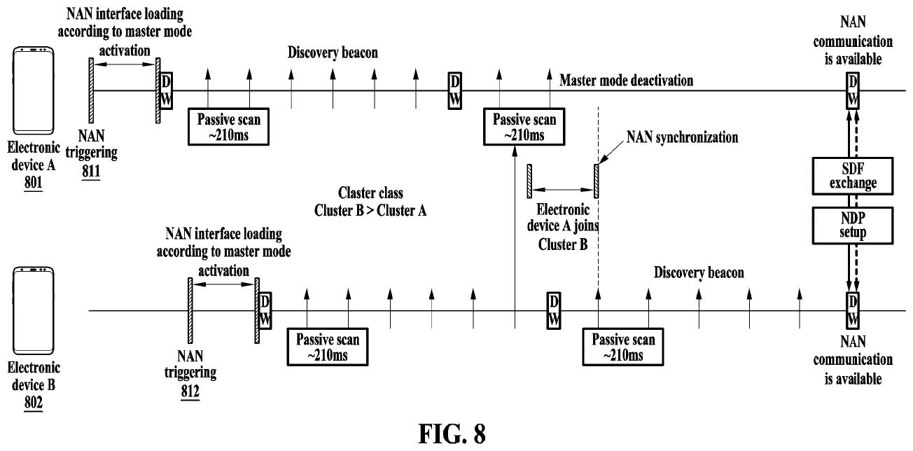

FIG. 8 is a diagram illustrating an operation of forming a NAN cluster.

Referring to FIG. 8, an electronic device A 801 and an electronic device B 802 may form a NAN cluster. The electronic device A 801 and the electronic device B 802 may be NAN terminals that support NAN, like the electronic devices 101, 102, 103, and 104 of FIG. 1, the electronic devices 301, 302, and 303 of FIG. 3, the electronic devices 400 and 410 of FIG. 4, and the electronic devices 602 and 603 of FIG. 6.

The electronic device A 801 and the electronic device B 802 may be NAN-triggered at different times. The electronic device A 801 and the electronic device B 802 may each activate a master mode. The electronic device A 801 and the electronic device B 802 may form a NAN cluster A and a NAN cluster B, respectively. The electronic device A 801 and the electronic device B 802 may each periodically transmit discovery beacons for an interval between DWs. The electronic device A 801 and the electronic device B 802 may each perform passive scanning periodically (e.g., about 210 ms). The electronic device B 802 may receive the discovery beacons transmitted by the electronic device A 801. The electronic device B 802 may receive the discovery beacons transmitted by the electronic device A 801. The electronic device A 801 and the electronic device B 802 may each compare the cluster class of the NAN cluster A formed by the electronic device A 801 and the cluster class of the NAN cluster B formed by the electronic device B 802. Through the comparison of the cluster classes, an electronic device (e.g., the electronic device A 801 or the electronic device B 802) may determine whether to maintain the master mode. Since the method of comparing the cluster classes has been described with reference to FIG. 3, the detailed description thereof is omitted. For example, when the class of the cluster B is higher than that of the cluster A, the electronic device B 802 forming the cluster B may be set as a master device. The electronic device B 802 may maintain the master mode, and the electronic device A 801 may turn off the master mode and then be synchronized with the cluster B. After the electronic device A 801 is synchronized (e.g., time-synchronized or channel-synchronized) with the cluster B, NDP setup may be performed.

As described above with reference to FIG. 8, it may take a lot of time until the electronic device A 801 and the electronic device B 802 are capable of NAN-based communication after NAN triggering. After NAN triggering, it may take a lot of time to activate a NAN interface, perform passive scanning, perform a cluster class comparison, and perform synchronization (e.g., time synchronization or channel synchronization). If there is an issue with beacon reception due to congestion in the network environment, it may take more time. In addition, as described above with reference to FIG. 6, the electronic device B 802 (e.g., the master device) may need to be activated during all DWs and may also need to be activated intermittently even for an interval between DWs. The electronic device B 802 (e.g., the master device) may consume greater current compared to the electronic device A 801 (e.g., the non-master device) as maintaining the cluster B (e.g., continuously performing synchronization between the electronic device A 801 and the electronic device B 802 included in the NAN cluster B).

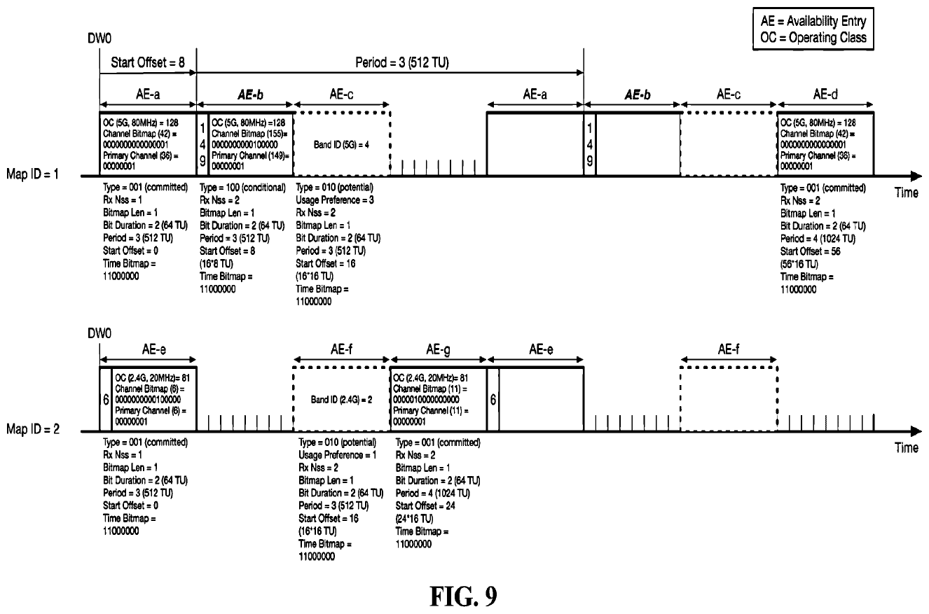

FIG. 9 is a diagram illustrating a NAN data link schedule.

According to an embodiment, two NAN devices (e.g., a pair of NAN devices) may form a NAN data link (NDL) between themselves. The NDL may indicate resource blocks negotiated between the pair of NAN devices. The pair of NAN devices may exchange data in an NDP, based on the NDL. One NDL may include at least one NDP. NDPs included in one NDL may respectively correspond to different services (e.g., a NAN service). Each of the NDPs may indicate a data connection set between the pair of NAN devices for a service instance.

According to an embodiment, an NDL may have a unique NDL schedule. An NDL schedule may have at least one time block between DWs. A time block may be set as a group of a plurality of consecutive slots in a 16-TU unit. “1” of an NDL schedule may correspond to a bitmap indicating availability for a designated time and “0” may correspond to a bitmap indicating unavailability for a designated time. A bitmap may include information on an NDL schedule. Bitmaps may respectively correspond to NDL schedules. A bitmap may have a map ID, and different map IDs may respectively correspond to different NDL schedules. Information on a bitmap may include a NAN availability attribute. FIG. 9 illustrates the examples of NDL schedules including NAN availability attribute information.

According to an embodiment, a NAN availability attribute may include a plurality of fields (e.g., Attribute ID, Length, Sequence ID, Attribute Control, and Availability Entry List). Table 3 shows the format of the NAN availability attribute.

TABLE 3

| | Size | | |
|---|---|---|---|
| Field | (octets) | Value | Description |
| Attribute | 1 | 0x12 | Identifies the type of a NAN attribute. |
| ID | | | |
| Length | 2 | Variable | The length in octets of the fields following the |
| | | | length field in the attribute. |
| Sequence | 1 | Variable | An integer value that identifies the sequence of the |
| ID | | | advertised availability schedule. It is incremented |
| | | | by one when any schedule change flag in the |
| | | | Attribute Control field is set to 1; otherwise, it |
| | | | remains unchanged. |
| Attribute | 2 | Variable | Refer to Table 2. |
| Control | | | |
| Availability | Variable | Variable | Including one or more Availability Entries. The |
| Entry List | | | format of an Availability Entry List is in Table 3. |

Table 4 shows the format of the Attribute Control field included in the NAN availability attribute. The Attribute Control field may include a plurality of fields (e.g., Map ID, Committed Changed, Potential Changed, Public Availability Attribute Changed, NDC Attribute Changed, Reserved (Multicast Schedule Attribute Changed), Reserved (Multicast Schedule Change Attribute Changed), and Reserved).

TABLE 4

| | Size | | |
|---|---|---|---|
| Field | (bits) | Value | Description |
| Map | 4 | Variable | Identify the associated NAN availability |
| ID | | | attribute |
| Committed | 1 | 0 or 1 | Set to 1 if Committed Availability |
| Changed | | | changed, compared with the last |
| | | | scheduled advertisement; or any |
| | | | Conditional Availability is included. |
| | | | Set to 0, otherwise. |
| | | | This setting shall be the same for all the |
| | | | maps in a frame. |
| Potential | 1 | 0 or 1 | Set to 1 if Potential Availability |
| Changed | | | changed, compared with last schedule |
| | | | advertisement. |
| | | | Set to 0, otherwise. |
| | | | This setting shall be the same |
| | | | for all the maps in a frame |
| Public | 1 | 0 or 1 | Set to 1 if Public Availability attribute |
| Availability | | | changed, compared with last schedule |
| Attribute | | | advertisement. |
| Changed | | | Set to 0, otherwise. |
| NDC | 1 | 0 or 1 | Set to 1 if NDC attribute changed, |
| Attribute | | | compared with last schedule |
| Changed | | | advertisement. |
| | | | Set to 0, otherwise. |
| Reserved | 1 | 0 or 1 | Set to 1 if Multicast Schedule attribute |
| (Multicast | | | changed, compared with last schedule |
| Schedule | | | advertisement. |
| Attribute | | | Set to 0, otherwise. |
| Changed) | | | |
| Reserved | 1 | 0 or 1 | Set to 1 if Multicast Schedule Change |
| (Multicast | | | attribute changed, compared with last |
| Schedule | | | schedule advertisement. |
| Change | | | Set to 0, otherwise. |
| Attribute | | | |
| Changed) | | | |
| Reserved | 6 | Variable | Reserved |

Table 5 shows the format of the Availability Entry List field included in the NAN availability attribute. The Availability Entry List field may include a plurality of fields (e.g., Length, Entry Control, Time Bitmap Control, Time Bitmap Length, Time Bitmap, and Band/Channel Entry List).

TABLE 5

| | Size | | |
|---|---|---|---|
| Field | (octets) | Value | Description |
| Length | 2 | Variable | The length of the fields following the Length |
| | | | field in the attribute, in the number of octets. |
| Entry Control | 2 | Variable | See Table 4 for details. |
| Time Bitmap | 2 | Variable | Indicates the parameters associated with the |
| Control | | | subsequent Time Bitmap field. See Table 5 for |
| | | | details. |
| Time Bitmap | 1 | Variable | Indicate the length of the following Time Bitmap |
| Length | | | field, in the number of octets. |
| Time Bitmap | Variable | Variable | Each bit in the Time Bitmap corresponds to a |
| | | | time duration indicated by the value of Bit |
| | | | Duration subfield in the Time Bitmap Control |
| | | | field. |
| | | | When the bit is set to 1, the NAN Device |
| | | | indicates its availability for any NAN operations |
| | | | for the whole time duration associated with the |
| | | | bit. |
| | | | When the bit is set to 0, the NAN Device |
| | | | indicates unavailable for any NAN-related |
| | | | operations for the time duration associated with |
| | | | the bit. |
| Band/Channel | Variable | Variable | The list of one or more Band or Channel Entries |
| Entry List | | | corresponding to this Availability Entry. See |
| | | | Table 6 for details. |

Table 6 shows the format of the Time Bitmap Control field included in the Availability Entry List field. The Time Bitmap Control field may include a plurality of fields (e.g., Bit Duration, Period, Start Offset, and Reserved). The Bit Duration field may correspond to the duration of a window (e.g., further available window or unaligned window) included in the NDL schedule. The Period field may correspond to a repetition period of the window included in the NDL schedule. The Start Offset field may correspond to a start time of the window included in the schedule.

TABLE 6

| Bit(s) | Field | Notes |
|---|---|---|
| 0-2 | Bit | 0: 16 TU |
| | Duration | 1: 32 TU |
| | | 2: 64 TU |
| | | 3: 128 TU |
| | | 4-7 reserved |
| 3-5 | Period | Indicate the repeat interval of the |
| | | following bitmap. When set to 0, the |
| | | indicated bitmap is not repeated. |
| | | When set to non-zero, the |
| | | repeat interval is: |
| | | 1: 128 TU |
| | | 2: 256 TU |
| | | 3: 512 TU |
| | | 4: 1024 TU |
| | | 5: 1048 TU |
| | | 6: 4096 TU |
| | | 7: 8192 TU |
| 6-14 | Start | Start Offset is an integer. The time |
| | Offset | period specified by the Time Bitmap |
| | | field starts at the 16 * Start Offset |
| | | TUs after DW0. |
| | | Note that the NAN Slots not covered by |
| | | any Time Bitmap are assumed to be |
| | | NOT available. |
| 15 | Reserved | Reserved |

Table 7 shows a Band/Channel Entries List field included in the Availability Entry List field. The Band/Channel Entries List field may include a plurality of fields (e.g., Type, Non-contiguous Bandwidth, Reserved, Number of Band or Channel Entries, and Band or Channel Entries). The Band or Channel Entries field may include one or more Band Entries and/or one or more Channel Entries.

TABLE 7

| Bit(s) | Field | Description |
|---|---|---|
| 0 | Type | Specifies whether the list refers to a set of indicated bands |
| | | or a set of operating classes and channel entries. |
| | | 0: The list is a set of indicated bands. |
| | | 1: the list is a set of Operating Classes and channel entries |
| 1 | Non- | 0: Contiguous bandwidth |
| | contiguous | 1: Non-contiguous bandwidth |
| | Bandwidth | This field is set to 1 if there is at least one Channel Entry |
| | | indicates non-contiguous bandwidth. |
| 2-3 | Reserved | Reserved |
| 4-7 | Number of | The number of band entries or channel entries on the list. |
| | Band or | Value 0 is reserved. |
| | Channel | |
| | Entries | |
| Variable | Band or | If the Type value is 0, including one or more Band Entries, |
| | Channel | as shown in FIG. 55 in Neighbor Awareness Networking |
| | Entries | Technical Specification. The value of each Band Entry is |
| | | specified by the Table 9-63 Band ID field in IEEE Std. |
| | | 802.11, which is also quoted in Table 7. |
| | | If the Type value is 1, including one or more |
| | | Channel Entries as in Table 8. |

The NAN availability attribute including the fields shown in Tables 3 to 7 may be transmitted and received through NAN frames (e.g., an SDF, an NDF, a synchronization beacon, or a discovery beacon).

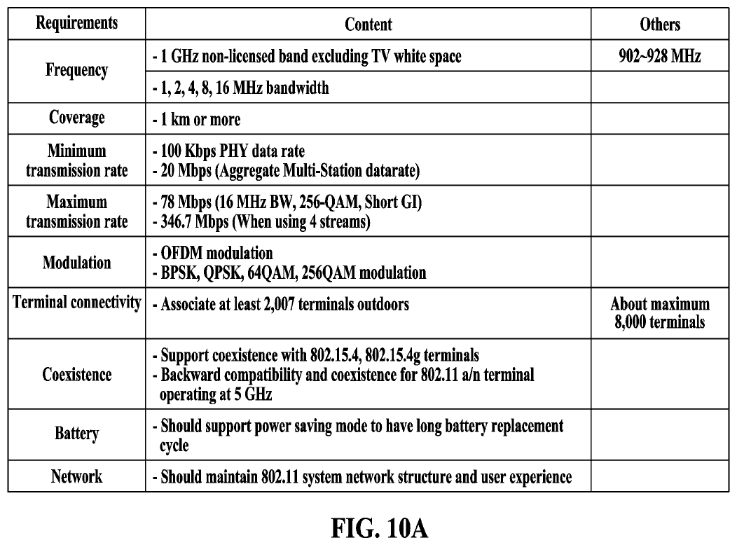

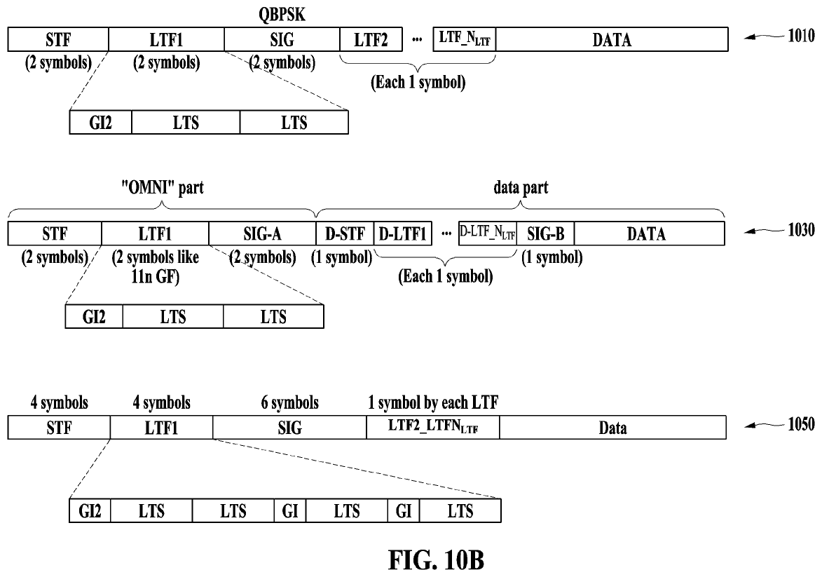

FIGS. 10A and 10B are diagrams each illustrating a high efficiency low power (HaLow) protocol.

According to an embodiment, Wi-Fi HaLow may refer to a device provided with the low-power Wi-Fi standard (IEEE 802.11ah) in the Wi-Fi alliance. A typical Wi-Fi protocol may use a frequency band of 2.4 GHz and/or 5 GHZ. The HaLow protocol may use a frequency band less than or equal to 1 GHz. The HaLow protocol may be a protocol that consumes low power. The HaLow protocol may perform typical long-distance transmission and may be a protocol that may service up to 1 km. The HaLow protocol may be a protocol that may cover a broadband.

According to an embodiment, to support features, such as ‘association of multiple terminals’ and ‘wide-range service region’, required from a sensor network, the HaLow protocol may apply various modifications to a first network layer (e.g., a physical layer) and a second network layer (e.g., a link layer or a medium-access control layer).

According to an embodiment, FIG. 10A illustrates design requirements of the HaLow protocol. The HaLow protocol may use Sub-1 GHz frequency band. Sub-1 GHz frequency band may have a physical feature robust to large-scale fading, compared to frequency bands, such as 2.4 GHZ, 5 GHZ, and 6 GHz. In the HaLow protocol using Sub-1 GHz frequency band, compared to other frequency bands, a signal may be less attenuated even if moving the same distance. The HaLow protocol may support a transmission range up to 1 km, based on relatively small signal attenuation characteristics. The bandwidth of the HaLow protocol may have 1, 2, 4, 8 and 16 MHZ. The HaLow protocol may reduce power consumption required to use a high-frequency band and a wide bandwidth. The HaLow protocol may basically use orthogonal frequency-division multiplexing (OFDM) modulation that is robust to a multi-path. The modulation and coding scheme (MCS) of the HaLow protocol may vary depending on the bandwidths and data streams used. The MCS of the HaLow protocol when a stream is one with 1 MHz bandwidth used to support the widest transmission range is shown in Table 8.

TABLE 8

| | | | Transmission rate (kbps) | |
|---|---|---|---|---|
| MCS | Modulation | Code | Long Guard | Short Guard |
| Level | Method | Rate | Interval | Interval |
| 0 | BPSK | 1/2 | 300 | 333.3 |
| 1 | QPSK | 1/2 | 600 | 666.7 |
| 2 | QPSK | 3/4 | 900 | 1000 |
| 3 | 16-QAM | 1/2 | 1200 | 1333.3 |
| 4 | 16-QAM | 3/4 | 1800 | 2000 |
| 5 | 64-QAM | 2/3 | 2400 | 2666.7 |
| 6 | 64-QAM | 3/4 | 2700 | 3000 |
| 7 | 64-QAM | 5/6 | 3000 | 3333.3 |
| 8 | 256-QAM | 3/4 | 3600 | 4000 |
| 9 | 256-QAM | 5/6 | 4000 | 4444.4 |
| 10 | BPSK | 1/2 with 2x | 150 | 166.7 |
| | | repetition | | |

In Table 8, unlike MCS level 0 to MCS level 9, MCS level 10 may be a level to support a maximum or high transmission range (e.g., 1 km). At MCS level 10, repeated encryption (e.g., encryption twice) may be performed to increase a transmission distance, and a transmission rate after the encryption may be reduced to ½. In the HaLow protocol, a physical-layer protocol data unit (PPDU) for 1 MHz bandwidth-based communication may be different from other PPDUs.

According to an embodiment, FIG. 10B illustrates the examples (e.g., an S1G short frame 1010, an S1G long frame 1030, or an S1G 1M frame 1050) of PPDUs used in the HaLow protocol. The S1G 1M frame 1050 may be the example of a PPDU for 1 MHz bandwidth-based communication. The number of symbols allocated to a short training field (STF) in the S1G 1M frame 1050 may be double compared to the S1G short frame 1010 and the S1G long frame 1030. In addition, the number of symbols allocated to a long training field (LTF) in the S1G 1M frame 1050 by repeating a guard interval (GI) and a long training sequence (LTS) twice in the LTF may be double compared to the S1G short frame 1010 and the S1G long frame 1030. By using the S1G 1M frame 1050 with the increased number of symbols allocated to channel estimation as described above, the HaLow protocol may reduce performance degradation caused by channel variation upon 1 MHz bandwidth-based communication.

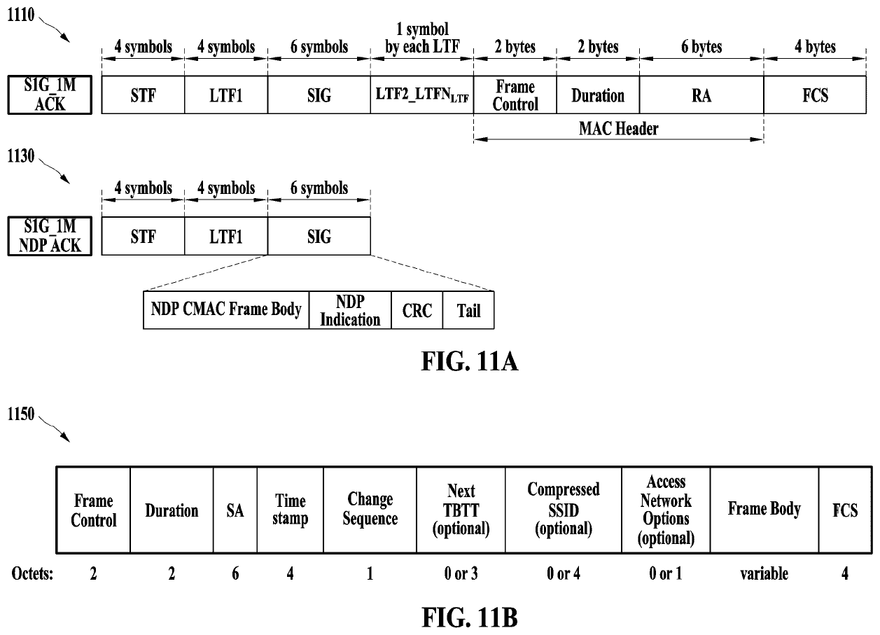

FIGS. 11A and 11B are diagrams each illustrating a frame used in a HaLow protocol.

According to an embodiment, FIG. 11A illustrates the examples (e.g., an S1G 1M acknowledgment (ACK) medium access control (MAC) frame 1110 and an S1G 1M null data packet carrying (NDP) MAC frame 1130) of a MAC frame used in the HaLow protocol. The S1G 1M NDP MAC frame 1130 may be a lightweight MAC frame for the operation of a sensor network. A S1G field of the S1G 1M NDP MAC frame 1130 may include minimum fields. The S1G 1M NDP MAC frame 1130 may be used as a clear-to-send (CTS) frame, a power-saving poll frame, a block ACK frame, and a probe request frame.

According to an embodiment, FIG. 11B illustrates the example of a MAC beacon (e.g., a Sub-1 GHz MAC beacon 1150) used in the HaLow protocol. A beacon signal may be used to synchronize AP and STA included in a BSS. To support a low-power operation and a wide transmission range, the HaLow protocol may include information selectively in fields included in the Sub-1 GHz MAC beacon 1150. For example, a beacon that causes some pieces of required information to be included in a Frame Body field of the Sub-1 GHz MAC beacon 1150 may be referred to as a short beacon. For example, a beacon that causes all the required information to be included in the Frame Body field of the Sub-1 GHz MAC beacon 1150 may be referred to as a full beacon. The HaLow protocol may include information like traffic indication map (TIM) information and a restricted access window parameter set (RPS) in the Frame Body field of the short beacon. Table 9 shows information that may be included in the Frame Body field of the Sub-1 GHz MAC beacon 1150.

TABLE 9

| | | | Allowed in | Allowed in |
|---|---|---|---|---|
| Order | Information | Notes | minimum set | full set |
| 1 | SIG Beacon | The SIG Beacon Compatibility element is | NO | YES |
| | Compatibility | present within SIG Beacon flames generated at | | |
| | | TBTTs. | | |
| 2 | Traffic | The TIM element is present within SIG Beacon | YES | YES |
| | indication | frames generated by APs at TBTTs and is | | |
| | map (TIM) | optionally present otherwise. | | |
| 3 | FMS | The FMS Descriptor element is present if | YES | YES |
| | Descriptor | dot11FMSActivated is true. | | |
| 4 | RPS | The RPS element is optionally present if | YES | YES |
| | | dot11RAWOperationActivated is true | | |
| 5 | SST Operation | The SST Operation element is present if | NO | YES |
| | element | dot11SelectiveSubchannelTransmissionPermitted | | |
| | | is true. | | |
| 6 | Subchannel | The Subchannel Selective Transmission | YES | YES |
| | Selective | element is optionally present if | | |
| | Transmission | dot11SubchannelSelectiveTransmissionActivated | | |
| | | is true. | | |
| 7 | SIG Relay | The SIG Relay element is optionally present if | YES | YES |
| | | dot11RelayAPImplemented is true. | | |
| 8 | Page Slice | The Page Slice element is optionally present if | NO | YES |
| | | dot11PageSlicingActivated is true. | | |
| 9 | SIG Sector | The SIG Sector Operation element is optionally | NO | YES |
| | Operation | present if dot11SIGSectorizationActivated is true. | | |
| 10 | Authentication | The Authentication Control element is | NO | YES |
| | Control | optionally present when | | |
| | | dot11SIGCentralizedAuthenticationControlActivated | | |
| | | is true or dot11SIGDistributedAuthenticationControlActivated | | |
| | | is true. | | |
| 11 | TSF Timer | The TSF Timer Accuracy element is optionally present when | NO | YES |
| | Accuracy | dot11TSFTimerAccuracyImplemented is true. | | |
| 12 | SIG Relay | The SIG Relay Discovery element is optionally | NO | YES |
| | Discovery | present if dot11RelayDiscoveryOptionImplemented is true. | | |
| 13 | SIG | The SIG Capabilities element is present if | NO | YES |
| | Capabilities | dot11SIGOptionImplemented is true; otherwise not present. | | |
| 14 | SIG Operation | The SIG Operation element is present when | NO | YES |
| | | dot11SIGOptionImplemented is true; otherwise not present. | | |
| 15 | Short Beacon | The Short Beacon Interval element is present if | NO | YES |
| | Interval | dot11ShortBeaconInterval is true. | | |
| Last-1 | One or more | These elements are optionally present and | NO | YES |
| | elements can | follow all other elements that are not vendor- | | |
| | appear in this | specific elements and precede all other elements | | |
| | fame. | that are vendor-specific elements that are part of the | | |
| | | Last field in the frame. | | |
| Last | Vendor | One of more vendor-specific elements are | NO | YES |
| | Specific | optionally present. These elements follow all | | |
| | | other elements. | | |

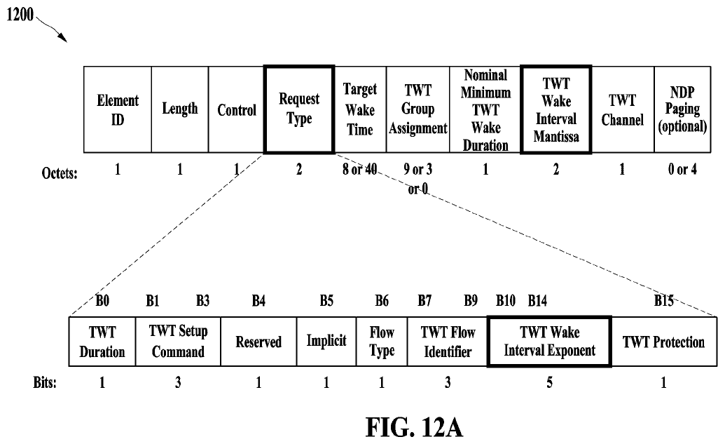

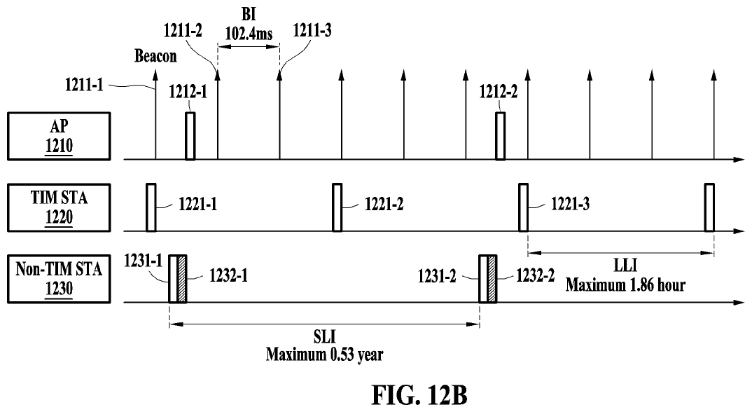

In the HaLow protocol, the short beacon may be transmitted every target short beacon transmission time (TSBTT). In the HaLow protocol, the full beacon may be transmitted at every target beacon transmission time (TBTT). The cycle of TBTT during which the full beacon is transmitted may be n times the cycle of TSBTT during which the short beacon is transmitted. In the HaLow protocol, the short beacon may have less information than that of the full beacon but may be transmitted more frequently. FIGS. 12A and 12B are diagrams each illustrating a protocol associated with a HaLow protocol.

According to an embodiment, IEEE 802.11ah supporting the HaLow protocol also supports other protocols. For example, IEEE 802.11ah supports a target wake time (TWT) protocol and a protocol related to a non-TIM operation. The TWT protocol may be used for STA to perform data transmission and reception during a certain TWT duration at every certain TWT interval. In the TWT protocol, TWT may be a time resource set to manage activity in BSS of STA. TWT parameters (e.g., start time information of a TWT service period, the TWT duration information of the TWT service period, and/or the TWT interval information of the TWT service period) may be set to minimize or reduce the operation of a wake-up state (or an awake state) (e.g., a wake-up mode) of STA. A plurality of STAs may operate at a designated time depending on the TWT parameters.

According to an embodiment, FIG. 12A illustrates a TWT element 1200 to set the TWT parameters. The TWT element 1200 may correspond to a TWT element format according to IEEE 802.11 (e.g., IEEE 802.11ah). According to an embodiment, the TWT element 1200 may include an element ID field, a length field, a control field, a request type field, a target wake time field, a TWT group assignment field, a nominal minimum TWT wake duration field, a TWT wake interval mantissa field, a TWT channel field (an N field), and an NDP paging field. In this case, the request type field may include a plurality of sub-fields, for example, a TWT duration field, a TWT setup command field, a reserved field, an implicit field, a flow type field, a TWT flow identifier field, a TWT wake interval exponent field, and a TWT protection field.

According to an embodiment, the TWT parameter (e.g., start time information of a TWT service period, duration information of the TWT service period, and/or TWT interval information of the TWT service period) may be determined by setting a value of at least one field of the plurality of fields included in the TWT element 1200. The start time of the TWT service period may be set in the target wake time field of the TWT element 1200, and the TWT duration for which the TWT service period persists (or is maintained) may be set in the nominal minimum TWT wake duration field of the TWT element 1200. A TWT interval (e.g., the value of an interval) of the TWT service period may be determined by the values set in the TWT wake interval mantissa field and the TWT wake interval exponent field of the TWT element 1200. Information on a mantissa to determine the TWT interval in the TWT wake interval mantissa field may be set, and information on an exponent value of which a base is 2 to determine the TWT interval in the TWT wake interval exponent field may be set. The size of the TWT interval may be determined based on the TWT wake interval mantissa×2^{(TWT wake interval exponent)}. Tf following the TWT protocol, STA (e.g., TIM STA 1220 of FIG. 12B) may be activated at the start time of the TWT service period and may perform data transmission and reception. IEEE 802.11ah provides a protocol that causes, without waiting for a TWT duration period set to be long (e.g., set to be 0.53 years), STA (e.g., a non-TIM STA 1230 of FIG. 12B) to be activated and perform data transmission and reception.

According to an embodiment, FIG. 12B illustrates the example of a non-TIM operation. An AP 1210 may periodically transmit and receive beacon signals (e.g., beacon signals 1211-1 to 1211-3). The TIM STA 1220 may be activated at a time corresponding to a transmission and reception time of a beacon signal (e.g., the beacon signals 1211-1 to 1211-3) of the AP 1210 and may transmit data frames 1221-1, 1221-2, and 1221-3. The TIM STA 1220 may be activated at a time that is not a transmission and reception time of a beacon signal (e.g., the beacon signals 1211-1 to 1211-3) of the AP 1210 and may transmit data frames 1232-1 and 1232-2. The AP 1210 may send ACK frames 1212-1 and 1212-2 back to the non-TIM STA 1230 in response to the data frames 1232-1 and 1232-2.

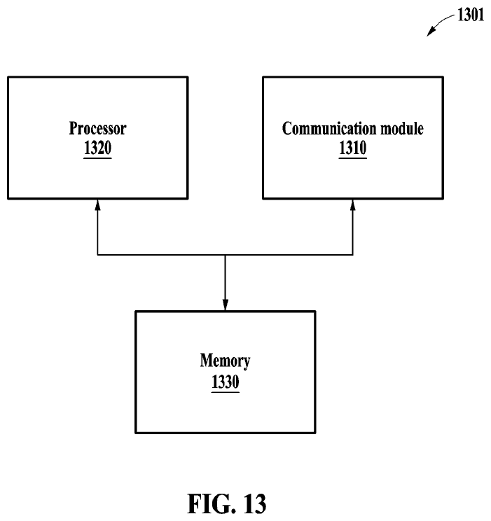

FIG. 13 is a schematic block diagram illustrating an electronic device according to an embodiment.

According to an embodiment, to provide a NAN service promptly in response to NAN triggering, an electronic device 1301 may use a communication module (e.g., a communication module, comprising communication circuitry, supporting the HaLow protocol or a communication module using Sub-1 GHz frequency band) capable of long-time reception standby by supporting low-power communication. The electronic device 1301 may provide a NAN communication method having both improved service responsiveness and low power characteristics by using a Sub-1 GHz communication module comprising communication circuitry. According to a comparative embodiment, as described above with reference to FIG. 8, it may take a lot of time until NAN-based communication is performed after NAN triggering. When NAN is triggered again after NAN communication between electronic devices included in the same NAN cluster is terminated, a series of procedures (e.g., activating a NAN interface, performing a passive scan, performing a cluster class comparison, and synchronization, e.g., time synchronization or channel synchronization) may be required to perform NAN communication. To solve time delay, a NAN cluster may be maintained even after NAN communication is terminated, but this may increase power consumption. According to an embodiment, the electronic device 1301 may maintain the association information (e.g., the synchronization information of a NAN cluster, NAN service information, or NAN data link schedule information) of the NAN cluster after NAN communication is terminated through a communication module comprising communication circuitry (e.g., a communication module supporting the HaLow protocol or a communication module using Sub-1 GHz frequency band) capable of long-time reception standby by supporting low-power communication. The electronic device 1301 may provide NAN communication having both improved service responsiveness and low power characteristics even when NAN is triggered again after NAN-based data transmission and reception is terminated by using a Sub-1 GHz communication module.

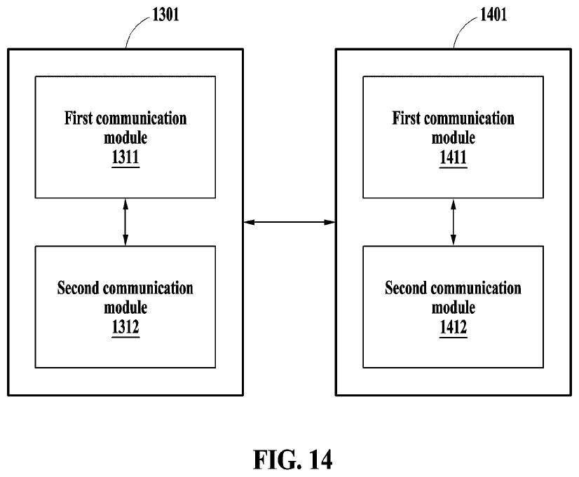

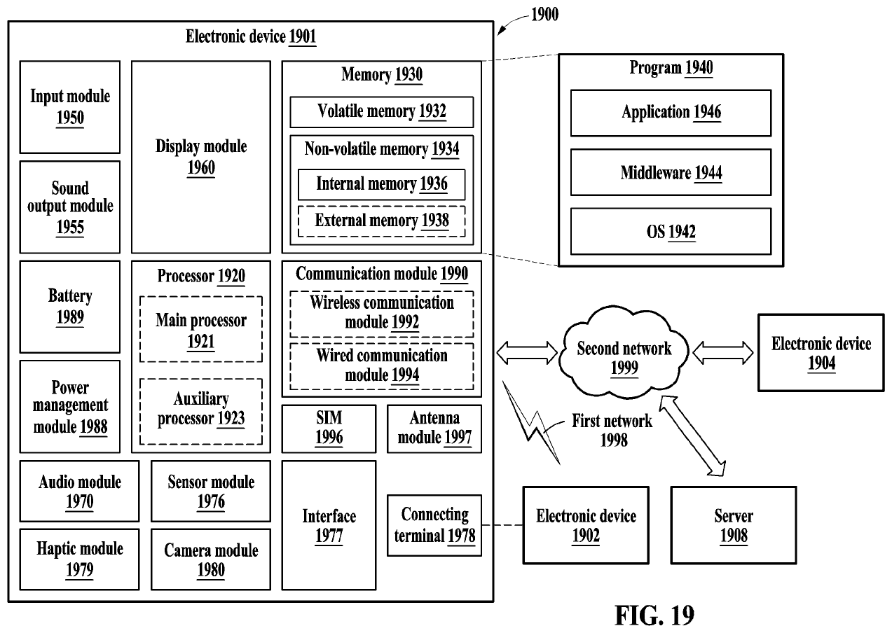

According to an embodiment, the electronic device 1301 may include one or more wireless communication modules 1310 comprising communication circuitry (e.g., a wireless communication module 1992 of FIG. 19), a processor 1320 (e.g., a processor 1920 of FIG. 19, comprising processing circuitry), and a memory 1330 (e.g., a memory 1930 of FIG. 19). The one or more wireless communication modules 1310 may include a first communication module (e.g., a first communication module 1311 of FIG. 14, comprising communication circuitry) and a second communication module (e.g., a second communication module 1312 of FIG. 14, comprising communication circuitry).

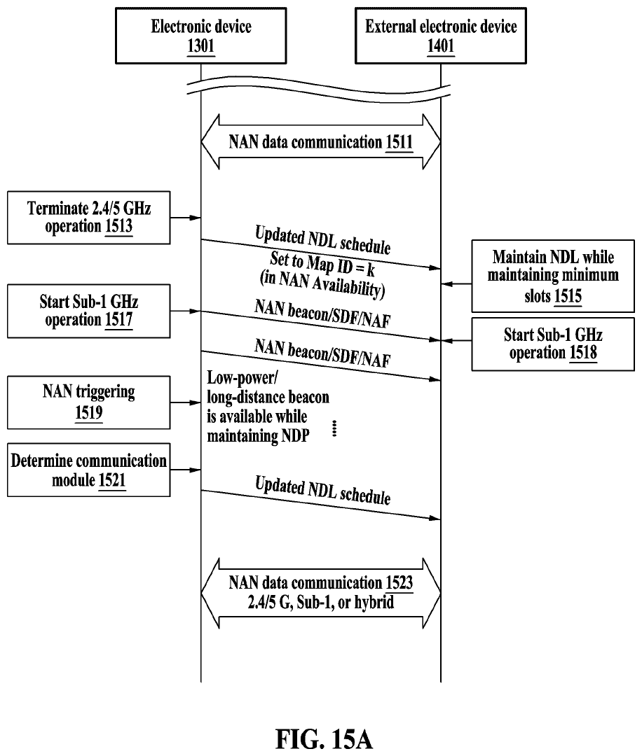

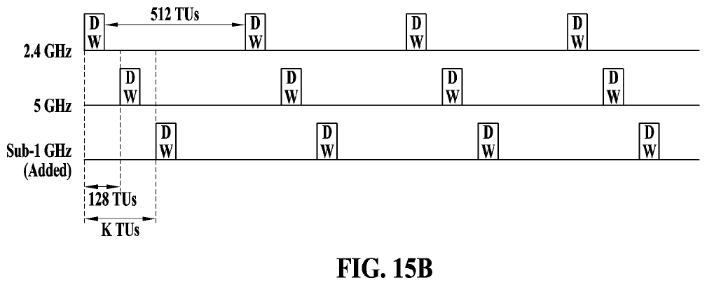

The first communication module may support a NAN protocol. The second communication module may support the HaLow protocol. The processor 1320 may be electrically and/or operatively connected to the one or more wireless communication modules 1310. The memory 1330 may be electrically connected to the processor 1320 and may store instructions executable by the processor 1320. The electronic device 1301 may correspond to an electronic device (e.g., an electronic device 1901 of FIG. 19) described with reference to FIG. 19. Accordingly, the repeated descriptions provided with reference to FIG. 19 are omitted. According to an embodiment, the processor 1320 may perform a plurality of operations through the one or more wireless communication modules 1310. The processor 1320 may perform data transmission and reception with an external electronic device (e.g., an external electronic device 1401 of FIG. 14) included together with the electronic device 1301 in a NAN cluster through the first communication module (e.g., the first communication module supporting the NAN protocol). The processor 1320 may transmit the association information of the NAN cluster to the external electronic device after terminating the transmitting and receiving data supported through the first communication module. The processor 1320 may hand off the association information of the NAN cluster from the first communication module to the second communication module (e.g., a second communication module supporting low-power communication with a low frequency band compared to a first communication module or a second communication module supporting the HaLow protocol). The processor 1320 may maintain the NAN cluster based on the association information of the NAN cluster through the second communication module. The operation of maintaining the NAN cluster based on the second communication module is described in detail with reference to FIGS. 15A and 15B. “Based on” as used herein covers based at least on.conected

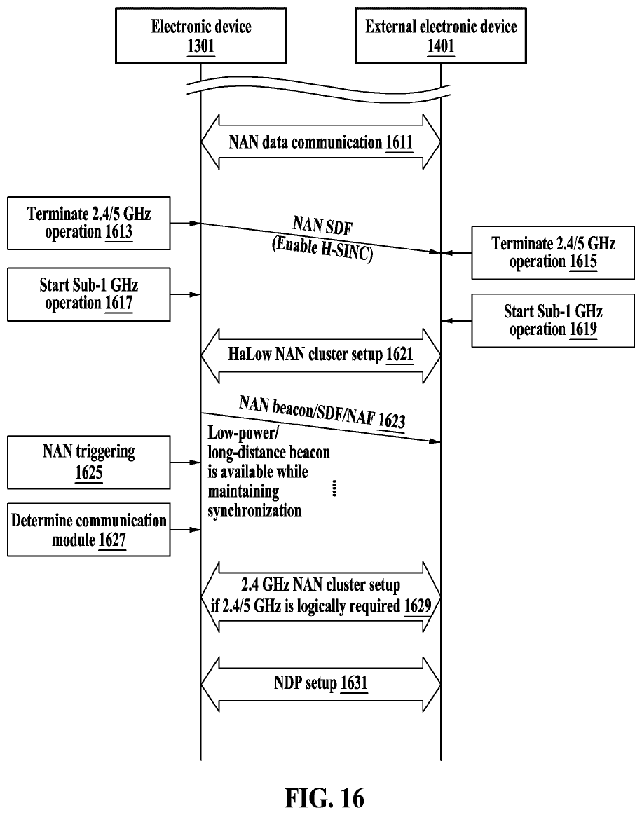

According to an embodiment, the processor 1320 may perform a plurality of operations through the one or more wireless communication modules 1310 each comprising communication circuitry. The processor 1320 may perform data transmission and reception with an external electronic device (e.g., the external electronic device 1401 of FIG. 14) included together with the electronic device 1301 in a first NAN cluster through the first communication module (e.g., the first communication module supporting the NAN protocol). The processor 1320 may transmit the association information of the first NAN cluster to the external electronic device after terminating the transmitting and receiving data supported through the first communication module. The processor 1320 may hand off the association information of the NAN cluster from the first communication module to the second communication module (e.g., a second communication module supporting low-power communication with a low frequency band compared to a first communication module or a second communication module supporting the HaLow protocol). The processor 1320 may form a second NAN cluster based on the association information of the first NAN cluster through the second communication module. The operation of newly forming the second NAN cluster based on the second communication module is described in detail with reference to FIG. 16.

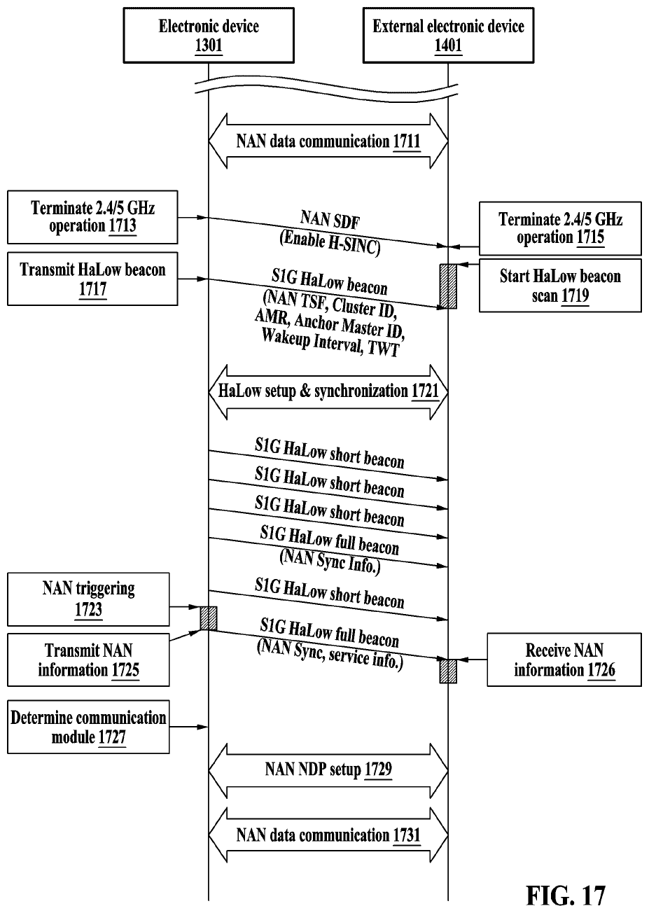

According to an embodiment, the processor 1320, comprising processing circuitry, may perform a plurality of operations through the one or more wireless communication modules 1310. The processor 1320 may perform data transmission and reception with the external electronic device (e.g., the external electronic device 1401 of FIG. 14) included together with the electronic device 1301 in a NAN cluster through the first communication module (e.g., the first communication module supporting the NAN protocol). The processor 1320 may hand off the association information of the NAN cluster from the first communication module to the second communication module (e.g., a second communication module supporting the HaLow protocol) after data transmission and reception supported through the first communication module is terminated. The processor 1320 may transmit the association information of the NAN cluster and the association information of the HaLow protocol to the external electronic device through the second communication module. The processor 1320 may perform HaLow setup with the external electronic device, based on the association information of the HaLow protocol, through the second communication module. The processor 1320 may maintain the association information of the NAN cluster by transmitting a HaLow beacon including the association information of the NAN cluster to the external electronic device through the second communication module. By using the HaLow beacon (e.g., the HaLow beacon transmitted through the second communication module), the operation of maintaining cluster-association information is described in detail with reference to FIG. 17.

FIG. 14 is a diagram illustrating information exchange performed by an electronic device and an external electronic device.

Referring to FIG. 14, according to an embodiment, the electronic device 1301 may include one or more wireless communication modules each comprising communication circuitry (e.g., a first communication module 1311 or a second communication module 1312). The external electronic device 1401 may include one or more wireless communication modules (e.g., a first communication module 1411 or a second communication module 1412). The first communication module 1311 or 1411 may support a NAN protocol. The second communication module 1312 or 1412 may use a frequency band different from that of the first communication module 1311. The second communication module 1312 may support low-power communication by using a low frequency band compared to the first communication module 1311. For example, the second communication module 1312 may support the HaLow protocol. The electronic device 1301 and the external electronic device 1401 may be devices supporting the NAN protocol and the HaLow protocol in parallel.

According to an embodiment, the electronic device 1301 and the external electronic device 1401 may hand off the association information of a NAN cluster generated based on the NAN protocol from the first communication module 1311 or 1411 to the second communication module 1312 or 1412. In addition, the electronic device 1301 and the external electronic device 1401 may exchange the association information of the NAN cluster with each other.

FIGS. 15A to 15C are diagrams each illustrating an operating method of the electronic device according to an embodiment.

Operations 1511 to 1523 may be performed sequentially but not necessarily. For example, the order of operations 1511 to 1523 may be changed, and at least two operations may be performed in parallel.

According to an embodiment, in operation 1511, the electronic device 1301 (e.g., the electronic device 1901 of FIG. 19) may transmit and receive data to and from the external electronic device 1401 (e.g., an electronic device 1902 or 1904 of FIG. 19) through a first communication module (e.g., the first communication module 1311 of FIG. 14) supporting a NAN protocol. The electronic device 1301 and the external electronic device 1401 may be included in the same NAN cluster.

According to an embodiment, in operation 1513, the electronic device 1301 may transmit the association information of a NAN cluster (e.g., the NAN cluster including the electronic device 1301 and the external electronic device 1401) to the external electronic device 1401 after data transmission and reception supported through the first communication module (e.g., a first communication module supporting 2.4/5 GHz frequency band) is terminated. The electronic device 1301 may hand off the association information of the NAN cluster from the first communication module to the second communication module (e.g., a second communication module supporting low-power communication with a low frequency band compared to a first communication module, a second communication module supporting Sub-1 GHz frequency band, or the second communication module 1312 of FIG. 14) after data transmission and reception supported through the first communication module is terminated.

According to an embodiment, the association information of the NAN cluster may include the synchronization information of the NAN cluster, NAN service information, and/or NAN data link schedule information. The NAN data link schedule information may be transmitted by a NAN frame (e.g., an SDF, an NDP, a sync beacon, or a discovery beacon) including a corresponding NAN availability attribute. The electronic device 1301 may set a map ID (e.g., map ID included in the NAN availability attribute) corresponding to a NAN data link schedule (an NDL schedule) that occupies a minimum or small time slot. The electronic device 1301 may transmit the NAN availability attribute corresponding to the set map ID to the external electronic device 1401. In operation 1515, the external electronic device 1401 may maintain an NDL to the electronic device 1301 based on the NDL schedule that occupies the minimum or a small time slot.

According to an embodiment, in operation 1517, the electronic device 1301 may maintain the NAN cluster based on the association information of the NAN cluster through the second communication module (e.g., the second communication module 1312 of FIG. 14) supporting Sub-1 GHz frequency band. In operation 1518, the external electronic device 1401 may maintain the NAN cluster based on the association information of the NAN cluster through the second communication module (e.g., the second communication module 1412 of FIG. 14) supporting Sub-1 GHz frequency band. The electronic device 1301 may maintain synchronization with the external electronic device 1401 included in the NAN cluster by transmitting a NAN frame (e.g., a NAN beacon frame, an SDF, and/or an NAF) based on an NDL schedule (e.g., the NDL schedule that occupies the minimum time slot).

According to an embodiment, a NAN cluster supported through the first communication module (e.g., the first communication module 1311 of FIG. 14 or the first communication module 1411 of FIG. 14) and a NAN cluster supported through the second communication module (e.g., the second communication module 1312 of FIG. 14) may be synchronized based on the same TSF timer information and may have the same cluster ID.

According to an embodiment, the NAN cluster supported through the first communication module (e.g., the first communication module 1311 of FIG. 14 or the first communication module 1411 of FIG. 14) and the NAN cluster supported through the second communication module (e.g., the second communication module 1312 of FIG. 14) may have different schedules for the same NDL and may be supported by different frequency bands.

According to an embodiment, in operations 1519 and 1521, in response to triggering a NAN service, the electronic device 1301 may determine at least one communication module and an NDL schedule to support the NAN service. Referring to FIG. 15B, communication modules respectively supporting frequency bands may be synchronized. For example, DWs of Sub-1 GHz frequency band may be spaced apart from one another by K time units (TUs) than DWs of 2.4 GHz frequency band. The determined NDL schedule may be an optimal NDL schedule (e.g., an NLD schedule that occupies a maximum time slot) to achieve the requirements for a NAN service. The determined NDL schedule may be a different schedule from the NDL schedule that occupies the minimum time slot.

According to an embodiment, in operation 1523, the electronic device 1301, based on the determined at least one communication module and the determined data link schedule, may transmit and receive data to and from the external electronic device 1401. FIG. 16 is a diagram illustrating an operating method of the electronic device according to an embodiment.

Operations 1611 to 1631 may be performed sequentially but not necessarily. For example, the order of operations 1611 to 1631 may be changed, and at least two operations may be performed in parallel.

According to an embodiment, in operation 1611, the electronic device 1301 (e.g., the electronic device 1901 of FIG. 19) may transmit and receive data to and from the external electronic device 1401 (e.g., the electronic device 1902 or 1904 of FIG. 19) through a first communication module (e.g., the first communication module 1311 of FIG. 14) supporting a NAN protocol. The electronic device 1301 and the external electronic device 1401 may be included in the same NAN cluster (e.g., a first NAN cluster).

According to an embodiment, in operations 1613 and 1615, the electronic device 1301 may transmit an SDF notifying the termination of 2.4/5 GHz frequency band-based data transmission to the external electronic device 1401 after data transmission and reception supported through the first communication module (e.g., a first communication module supporting 2.4/5 GHz frequency band) is terminated. The electronic device 1301 may transmit the association information of a first NAN cluster (e.g., a NAN cluster including the electronic device 1301 and the external electronic device 1401). The electronic device 1301 may hand off the association information of the first NAN cluster from the first communication module to a second communication module (e.g., a second communication module supporting low-power communication with a low frequency band compared to a first communication module, a second communication module supporting Sub-1 GHz frequency band, or the second communication module 1312 of FIG. 14) after data transmission and reception supported through the first communication module is terminated. Each “communication module” herein may comprise communication circuitry.

According to an embodiment, the association information of the first NAN cluster may include the synchronization information of the first NAN cluster, NAN service information, and/or NAN data link schedule information. The NAN data link schedule information may be transmitted by a NAN frame (e.g., an SDF, an NDP, a sync beacon, or a discovery beacon) including a corresponding NAN availability attribute. The electronic device 1301 may set a map ID (e.g., map ID included in the NAN availability attribute) corresponding to a NAN data link schedule (an NDL schedule) that occupies a minimum time slot. The electronic device 1301 may transmit the NAN availability attribute corresponding to the set map ID to the external electronic device 1401. In operation 1615, the external electronic device 1401 may terminate data transmission and reception supported through the first communication module supporting 2.4/5 GHz frequency band.

According to an embodiment, in operations 1617 and 1619, the electronic device 1301 and the external electronic device 1401 may perform an operation based on the second communication module (e.g., the second communication module 1312 or 1412 of FIG. 14) supporting Sub-1 GHz frequency band. In operation 1621, the electronic device 1301 may form a second NAN cluster based on the association information of the first NAN cluster. The operation of forming a NAN cluster is described in detail with reference to FIG. 8 and thus is omitted. However, the second NAN cluster uses the same TSF timer information as that of the first NAN cluster, and thus, there may not be a delay due to time synchronization when forming the second NAN cluster.

According to an embodiment, in operation 1623, the electronic device 1301 may maintain synchronization with the external electronic device 1401 included in the second NAN cluster by transmitting a NAN frame (e.g., a NAN beacon frame, an SDF, and/or an NAF) based on an NDL schedule (e.g., the NDL schedule that occupies the minimum time slot).

According to an embodiment, the first NAN cluster supported through the first communication module (e.g., the first communication module 1311 of FIG. 14 or the first communication module 1411 of FIG. 14) and the second NAN cluster supported through the second communication module (e.g., the second communication module 1312 of FIG. 14) may have different cluster IDs and may be supported by different frequency bands.

According to an embodiment, in operations 1625 and 1627, in response to triggering a NAN service, the electronic device 1301 may determine at least one communication module and an NDL schedule to support the NAN service. According to an embodiment, in operation 1629, if the determined at least one communication module includes the first communication module supporting 2.4/5 GHZ, a third NAN cluster supported by the first communication module may be formed based on the association information of the second NAN cluster. The operation of forming the third NAN cluster may be substantially the same as the operation of forming the second NAN cluster, and thus detailed descriptions are omitted.

According to an embodiment, in operation 1631, the electronic device 1301, based on the determined at least one communication module and the determined data link schedule, may transmit and receive data to and from the external electronic device 1401.

FIG. 17 is a diagram illustrating an operating method of the electronic device according to an embodiment.

Operations 1711 to 1731 may be performed sequentially but not necessarily.

For example, the order of operations 1711 to 1731 may be changed, and at least two operations may be performed in parallel.

According to an embodiment, in operation 1711, the electronic device 1301 (e.g., the electronic device 1901 of FIG. 19) may transmit and receive data to and from the external electronic device 1401 (e.g., the electronic device 1902 or 1904 of FIG. 19) through a first communication module (e.g., the first communication module 1311 of FIG. 14) supporting the NAN protocol. The electronic device 1301 and the external electronic device 1401 may be included in the same NAN cluster.

According to an embodiment, in operations 1713 and 1715, the electronic device 1301 may transmit an SDF notifying the termination of 2.4/5 GHz frequency band-based data transmission to the external electronic device 1401 after data transmission and reception supported through the first communication module (e.g., a first communication module supporting 2.4/5 GHz frequency band) is terminated. The electronic device 1301 may transmit the association information of a NAN cluster (e.g., a NAN cluster including the electronic device 1301 and the external electronic device 1401). The electronic device 1301 may hand off the association information of the NAN cluster from the first communication module to the second communication module (e.g., a second communication module supporting the Halow protocol, a second communication module supporting Sub-1 GHz frequency band, or the second communication module 1312 of FIG. 14) after data transmission and reception supported through the first communication module is terminated.

According to an embodiment, in operation 1717, the electronic device 1301 (e.g., the electronic device 1301 functioning as a HaLow AP) may transmit the association information of the NAN cluster and the association information of the HaLow protocol to the external electronic device 1401. The association information of the NAN cluster may include the synchronization information of the NAN cluster, NAN service information, and/or NAN data link schedule information. The association information of the HaLow protocol may include TWT parameters for a TWT service, information on a cycle of a HaLow beacon, and/or information on a TIM mode. The electronic device 1301 may transmit S1G HaLow. In operation 1719, the external electronic device 1401 may perform a passive scan for the HaLow beacon and may receive the HaLow beacon.

According to an embodiment, in operation 1721, the electronic device 1301 and the external electronic device 1401 may perform HaLow setup based on the association information of the HaLow protocol. HaLow setup operations may include an association operation and/or an authentication operation. The electronic device 1301 may maintain the association information of the NAN cluster by transmitting the HaLow beacon including the association information of the NAN cluster to the external electronic device 1401 (e.g., the external electronic device 1401 for which the HaLow setup with the electronic device 1301 is completed) through the second communication module. The HaLow beacon (e.g., the HaLow beacon including the association information of the NAN cluster) may include a short beacon and/or a full beacon. The short beacon may have less information than that of the full beacon but may be transmitted more frequently. The short beacon may include some of the association information of the NAN cluster. The short beacon may be transmitted for the purpose of polling. The full beacon may include all the association information of the NAN cluster.

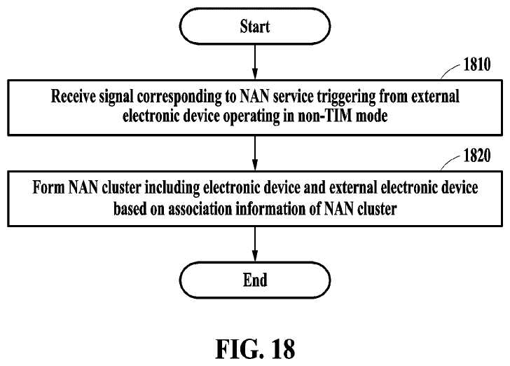

According to an embodiment, in operations 1723 and 1725, in response to triggering a NAN service, the electronic device 1301 may transmit the full beacon including all the association information of the NAN cluster. In operation 1726, the external electronic device 1401 may receive all the association information of the NAN cluster. The case where the electronic device 1301 (e.g., the electronic device 1301 functioning as a HaLow AP) receives a signal corresponding to the triggering of a NAN service from the external electronic device 1401 is described with reference to FIG. 18.

According to an embodiment, in operation 1727, the electronic device 1301 may determine at least one communication module to support a NAN service. In operation 1729, the electronic device 1301 and the external electronic device 1401 may perform NDP setup. In operation 1731, the electronic device 1301, based on the determined at least one communication, may transmit and receive data to and from the external electronic device 1401.

FIG. 18 is a flowchart illustrating an operating method of the electronic device according to an embodiment.

Operations 1810 and 1820 may be performed sequentially but not necessarily. For example, the order of operations 1810 and 1820 may be changed, and at least two operations may be performed in parallel.

According to an embodiment, in operation 1810, the electronic device (e.g., the electronic device 1301 of FIG. 13) may receive a signal corresponding to NAN service triggering from an external electronic device (e.g., the external electronic device 1401 of FIG. 14) operating in a non-TIM mode.

According to an embodiment, in operation 1820, the electronic device 1301 may form a NAN cluster including the electronic device 1301 and the external electronic device 1401 based on the association information of the NAN cluster.

According to an embodiment, the electronic device 1301 may maintain the association information (e.g., the synchronization information of a NAN cluster, NAN service information, or NAN data link schedule information) of the NAN cluster after

NAN communication is terminated through a communication module (e.g., a communication module supporting the HaLow protocol or a communication module using Sub-1 GHz frequency band) capable of long-time reception standby by supporting low-power communication. The electronic device 1301 may provide NAN communication having both improved service responsiveness and low power characteristics even when NAN is triggered again after NAN-based data transmission and reception is terminated by using a Sub-1 GHz communication module (e.g., a communication module supporting the HaLow protocol).

FIG. 19 is a block diagram illustrating the electronic device 1901 in a network environment 1900 according to an embodiment.

Referring to FIG. 13, the electronic device 1901 in the network environment 1900 may communicate with the electronic device 1902 via a first network 1998 (e.g., a short-range wireless communication network), or communicate with at least one of an electronic device 1904 or a server 1908 via a second network 1999 (e.g., a long-range wireless communication network). According to an embodiment, the electronic device 1901 may communicate with the electronic device 1904 via the server 1908. According to an embodiment, the electronic device 1901 may include the processor 1920, the memory 1930, an input module 1950, a sound output module 1955, a display module 1960, an audio module 1970, a sensor module 1976, an interface 1977, a connecting terminal 1978, a haptic module 1979, a camera module 1980, a power management module 1988, a battery 1989, a communication module 1990, a subscriber identification module (SIM) 1996, or an antenna module 1997. In some embodiments, at least one of the components (e.g., the connecting terminal 1978) may be omitted from the electronic device 1901, or one or more other components may be added to the electronic device 1901. In some embodiments, some of the components (e.g., the sensor module 1976, the sensor module 1980, or the antenna module 1997) may be integrated as a single component (e.g., the display module 1960).

The processor 1920 may execute, for example, software (e.g., a program 1940) to control at least one other component (e.g., a hardware or software component) of the electronic device 1901 connected, directly or indirectly, to the processor 1920 and may perform various data processing or computation. According to an embodiment, as at least a part of data processing or computations, the processor 1920 may store a command or data received from another component (e.g., the sensor module 1976 or the communication module 1990) in a volatile memory 1932, process the command or the data stored in the volatile memory 1932, and store resulting data in a non-volatile memory 1934. According to an embodiment, the processor 1920 may include the main processor 1921 (e.g., a CPU or an application processor (AP) 720), or an auxiliary processor 1923 (e.g., a GPU, an NPU, an image signal processor (ISP) 720, a sensor hub processor 720, or a communication processor (CP) 720) that is operable independently from, or in conjunction with the main processor 1921. For example, when the electronic device 1901 includes the main processor 1921 and the auxiliary processor 1923, the auxiliary processor 1923 may be adapted to consume less power than the main processor 1921 or to be specific to a designated function. The auxiliary processor 1923 may be implemented separately from the main processor 1921 or as a part of the main processor 1921.

The auxiliary processor 1923 may control at least some of the functions or states related to at least one (e.g., the display module 1960, the sensor module 1976, or the communication module 1990) of the components of the electronic device 1901 instead of the main processor 1921 while the main processor 1921 is in an inactive (e.g., sleep) state or along with the main processor 1921 while the main processor 1921 is an active state (e.g., executing an application). According to an embodiment, the auxiliary processor 1923 (e.g., an ISP 720 or a CP 720) may be implemented as a portion of another component (e.g., the camera module 1980 or the communication module 1990) that is functionally related to the auxiliary processor 1923. According to an embodiment, the auxiliary processor 1923 (e.g., an NPU) may include a hardware structure specified for the processing of an artificial intelligence model. An artificial intelligence model may be generated by machine learning. The machine learning may be performed by, for example, the electronic device 1901, in which artificial intelligence is performed, or performed via a separate server (e.g., the server 1908). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), and a deep Q-network or a combination of two or more thereof but is not limited thereto. The artificial intelligence model may additionally or alternatively include a software structure other than the hardware structure.

The memory 1930 may store various pieces of data used by at least one component (e.g., the processor 1920 or the sensor module 1976) of the electronic device 1901. The various pieces of data may include, for example, software (e.g., the program 1940) and input data or output data for a command related thereto. The memory 1930 may include the volatile memory 1932 or the non-volatile memory 1934.

The program 1940 may be stored as software in the memory 1930, and may include, for example, an operating system 1942, middleware 1944, or an application 1946.

The input module 1950 may receive a command or data to be used by another component (e.g., the processor 1920) of the electronic device 1901, from the outside (e.g., a user) of the electronic device 1901. The input module 1950 may include, for example, a microphone, a mouse, a keyboard, a key (e.g., a button), or a digital pen (e.g., a stylus pen).

The sound output module 1955 may output a sound signal to the outside of the electronic device 1901. The sound output module 1955 may include, for example, a speaker or a receiver. The speaker may be used for general purposes, such as playing multimedia or playing recordings. The receiver may be used to receive an incoming call. According to an embodiment, the receiver may be implemented separately from the speaker or as a portion of the speaker.

The display module 1960 may visually provide information to the outside (e.g., a user) of the electronic device 1901. The display module 1960 may include, for example, a display, a hologram device, or a projector and control circuitry to control a corresponding one of the display, hologram device, and projector. According to an embodiment, the display module 1960 may include a touch sensor adapted to detect a touch, or a pressure sensor adapted to measure the intensity of force incurred by the touch.

The audio module 1970 may convert a sound into an electrical signal or vice versa. According to an embodiment, the audio module 1970 may obtain the sound via the input module 1950 or output the sound via the sound output module 1955 or an external electronic device (e.g., the electronic device 1902 such as a speaker or a headphone) directly or wirelessly connected with the electronic device 1901.

The sensor module 1976 may detect an operational state (e.g., power or temperature) of the electronic device 1901 or an environmental state (e.g., a state of a user) external to the electronic device 1901, and then generate an electrical signal or data value corresponding to the detected state. According to an embodiment, the sensor module 1976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1977 may support one or more designated protocols to be used for the electronic device 1901 to be coupled with the external electronic device (e.g., the electronic device 1902) directly (e.g., by wire) or wirelessly. According to an embodiment, the interface 1977 may include, for example, a high-definition multimedia interface (HDMI), a universal serial bus (USB) interface, a secure digital (SD) card interface, or an audio interface.

The connecting terminal 1978 may include a connector via which the electronic device 1901 may be physically connected, directly or indirectly, with the external electronic device (e.g., the electronic device 1902). According to an embodiment, the connecting terminal 1978 may include, for example, an HDMI connector, a USB connector, an SD card connector, or an audio connector (e.g., a headphone connector).

The haptic module 1979 may convert an electric signal into a mechanical stimulus (e.g., a vibration or a movement) or an electrical stimulus, which may be recognized by a user via their tactile sensation or kinesthetic sensation. According to an embodiment, the haptic module 1979 may include, for example, a motor, a piezoelectric element, or an electric stimulator.

The sensor module 1980 may capture a still image and moving images. According to an embodiment, the camera module 1980 may include one or more lenses, image sensors, ISPs 720, or flashes.

The power management module 1988 may manage power supplied to the electronic device 1901. According to an embodiment, the power management module 1988 may be implemented as, for example, at least a part of a power management integrated circuit (PMIC).

The battery 1989 may supply power to at least one component of the electronic device 1901. According to an embodiment, the battery 1989 may include, for example, a primary cell that is not rechargeable, a secondary cell that is rechargeable, or a fuel cell.

The communication module 1990 may support establishing a direct (e.g., wired) communication channel or a wireless communication channel between the electronic device 1901 and the external electronic device (e.g., the electronic device 1902, the electronic device 1904, or the server 1908) and performing communication via the established communication channel. The communication module 1990 may include one or more CPs 720 that are operable independently from the processor 1920 (e.g., an AP 720) and that support direct (e.g., wired) communication or wireless communication.

According to an embodiment, the communication module 1990 may include the wireless communication module 1992 (e.g., a cellular communication module, a short-range wireless communication module, or a global navigation satellite system (GNSS) communication module) or a wired communication module 1994 (e.g., a local area network (LAN) communication module, or a power line communication (PLC) module). A corresponding one of these communication modules may communicate with the external electronic device 1904 via the first network 1998 (e.g., a short-range communication network, such as Bluetooth™, wireless-fidelity (Wi-Fi) direct, or IR data association (IrDA)) or the second network 1999 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multi-components (e.g., multi-chips) separate from each other. The wireless communication module 1992 may identify and authenticate the electronic device 1901 in a communication network, such as the first network 1998 or the second network 1999, using subscriber information (e.g., international mobile subscriber identity (IMSI)) stored in the SIM 1996.

The wireless communication module 1992 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1992 may support a high-frequency band (e.g., a mmWave band) to achieve, for example, a high data transmission rate. The wireless communication module 1992 may support various technologies for securing performance on a high-frequency band, such as, e.g., beamforming, massive multiple-input and multiple-output (MIMO), full dimensional MIMO (FD-MIMO), an array antenna, analog beamforming, or a large scale antenna. The wireless communication module 1992 may support various requirements specified in the electronic device 1901, the external electronic device (e.g., the electronic device 1904), or a network system (e.g., the second network 1999). According to an embodiment, the wireless communication module 1992 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1997 may transmit or receive a signal or power to or from the outside (e.g., the external electronic device). According to an example embodiment, the antenna module 1997 may include an antenna including a radiating element including a conductive material or a conductive pattern formed in or on a substrate (e.g., a printed circuit board (PCB)). According to an embodiment, the antenna module 1997 may include a plurality of antennas (e.g., array antennas). In such a case, at least one antenna appropriate for a communication scheme used in a communication network, such as the first network 1998 or the second network 1999, may be selected by, for example, the communication module 1990 from the plurality of antennas. The signal or the power may then be transmitted or received between the communication module 1990 and the external electronic device via the selected at least one antenna. According to an embodiment, another component (e.g., a radio frequency integrated circuit (RFIC)) other than the radiating element may be additionally formed as part of the antenna module 1997.

According to an embodiment, the antenna module 1997 may form a mm Wave antenna module. According to an embodiment, the mmWave antenna module may include a PCB, an RFIC on a first surface (e.g., the bottom surface) of the PCB, or adjacent to the first surface of the PCB and capable of supporting a designated high-frequency band (e.g., a mm Wave band), and a plurality of antennas (e.g., array antennas) arranged on a second surface (e.g., the top or a side surface) of the PCB, or adjacent to the second surface of the PCB and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1901 and the external electronic device 1904 via the server 1908 coupled with the second network 1999. Each of the external electronic devices 1902 or 1904 may be a device of the same type as or a different type from the electronic device 1901. According to an embodiment, all or some of the operations to be executed by the electronic device 1901 may be executed at one or more external electronic devices (e.g., the external devices 1902 and 1904, or the server 1908). For example, if the electronic device 1901 needs to perform a function or a service automatically, or in response to a request from a user or another device, the electronic device 1901, instead of, or in addition to, executing the function or the service, may request one or more external electronic devices to perform at least portion of the function or the service. The one or more external electronic devices receiving the request may perform at least part of the function or service, or an additional function or an additional service related to the request and may transfer a result of the performance to the electronic device 1901. The electronic device 1901 may provide the result, with or without further processing the result, as at least part of a response to the request. To that end, cloud computing, distributed computing, mobile edge computing (MEC), or client-server computing technology may be used, for example. The electronic device 1901 may provide ultra-low-latency services using, for example, distributed computing or MEC. In another embodiment, the external electronic device (e.g., the electronic device 1904) may include an Internet-of-things (IoT) device. The server 1908 may be an intelligent server using machine learning and/or a neural network. According to an embodiment, the external electronic device 1904 or the server 1908 may be included in the second network 1999. The electronic device 1901 may be applied to intelligent services (e.g., smart home, smart city, smart car, or healthcare) based on 5G communication technology or IoT-related technology.

The electronic device according to the embodiments disclosed herein may be one of various types of electronic devices. The electronic device may include, for example, a portable communication device (e.g., a smartphone), a computer device, a portable multimedia device, a portable medical device, a camera, a wearable device, or a home appliance device. According to an embodiment, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via at least a third element(s). Thus, “connected” herein for example covers both direct and indirect connections.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Embodiments as set forth herein may be implemented as software (e.g., the program 1940) including one or more instructions that are stored in a storage medium (e.g., an internal memory 1936 or an external memory 1938) that is readable by a machine (e.g., the electronic device 1901). For example, a processor 720 (e.g., the processor 1920) of the machine (e.g., the electronic device 1901) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)) or may be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a transmit server.

According to embodiments, each component (e.g., a module or a program) of the above-described components may include a single entity or multiple entities, and some of the multiple entities may be separately disposed in different components. According to embodiments, one or more of the above-described components or operations may be omitted, or one or more other components or operations may be added. Alternatively or additionally, a plurality of components (e.g., modules or programs) may be integrated into a single component. In such a case, according to an embodiment, the integrated component may still perform one or more functions of each of the components in the same or similar manner as they are performed by a corresponding one among the components before the integration. According to embodiments, operations performed by the module, the program, or another component may be carried out sequentially, in parallel, repeatedly, or heuristically, or one or more of the operations may be executed in a different order or omitted, or one or more other operations may be added.

According to an embodiment, an electronic device (e.g., the electronic device 1301 of FIG. 13 or the electronic device 1901 of FIG. 19) may include one or more wireless communication modules (e.g., the wireless communication module 1310 of FIG. 13 or the wireless communication module 1992 of FIG. 19) including a first communication module (e.g., the first communication module 1311 of FIG. 14) supporting a NAN protocol and a second communication module (e.g., the second communication module 1312 of FIG. 14) using a frequency band different from that of the first communication module. The electronic device may include one or more processors (e.g., the processor 1320 of FIG. 13 or the processor 1920 of FIG. 19) operatively connected to the one or more wireless communication modules. The electronic device may include a memory (e.g., the memory 1330 of FIG. 13 or the memory 1930 of FIG. 19) configured to store instructions. The instructions are executed individually and/or collectively, by the one or more processors 1320; 1920 to cause the electronic device 1301; 1901 to transmit and receive data to and from an external electronic device included in both a NAN cluster and the electronic device through the first communication module. The instructions are executed individually and/or collectively, by the one or more processors 1320; 1920 to cause the electronic device 1301; 1901 to transmit the association information of the first NAN cluster to the external electronic device after terminating the operation of transmitting and receiving data, supported through the first communication module. The instructions are executed individually and/or collectively, by the one or more processors 1320; 1920 to cause the electronic device 1301; 1901 to hand off the association information of the NAN cluster from the first communication module to the second communication module. The instructions are executed individually and/or collectively, by the one or more processors 1320; 1920 to cause the electronic device 1301; 1901 to maintain the NAN cluster based on the association information of the NAN cluster through the second communication module.

According to an embodiment, the second communication module may support low-power communication by using a low frequency band compared to the first communication module 1311.

According to an embodiment, the association information of the NAN cluster may include at least one of synchronization information of the NAN cluster, NAN service information, or NAN data link schedule information.

According to an embodiment, the NAN data link schedule information may be transmitted by a NAN frame comprising a corresponding NAN availability attribute.

According to an embodiment, a NAN cluster supported through the first communication module and a NAN cluster supported through the second communication module may be synchronized based on the same TSF timer information. The NAN cluster supported through the first communication module and the NAN cluster supported through the second communication module may have the same cluster ID.

According to an embodiment, the NAN cluster supported through the first communication module and the NAN cluster supported through the second communication module may have different schedules for the same NAN data link. The NAN cluster supported through the first communication module and the NAN cluster supported through the second communication module may be supported by different frequency bands.

According to an embodiment, the instructions are executed individually and/or collectively, by the one or more processors 1320; 1920 to cause the electronic device 1301; 1901 to reset a NAN data link schedule based on the association information of the NAN cluster. The instructions are executed individually and/or collectively, by the one or more processors 1320; 1920 to cause the electronic device 1301; 1901 to maintain synchronization between the electronic device and the external electronic device included in the NAN cluster by transmitting a NAN beacon frame, based on the reset NAN data link schedule.

According to an embodiment, the reset NAN data link schedule may be a NAN data link schedule that occupies a minimum time slot.

According to an embodiment, the instructions are executed individually and/or collectively, by the one or more processors 1320; 1920 to cause the electronic device 1301; 1901 to, in response to triggering a NAN service, determine at least one communication module and a data link schedule to support the NAN service. the instructions are executed individually and/or collectively, by the one or more processors 1320; 1920 to cause the electronic device 1301; 1901 to, based on the determined at least one communication module and the determined data link schedule, transmit and receiving data to and from the external electronic device.

According to an embodiment, an electronic device (e.g., the electronic device 1301 of FIG. 13 or the electronic device 1901 of FIG. 19) may include one or more wireless communication modules (e.g., the wireless communication module 1310 of FIG. 13 or the wireless communication module 1992 of FIG. 19) including a first communication module (e.g., the first communication module 1311 of FIG. 14) supporting a NAN protocol and a second communication module (e.g., the second communication module 1312 of FIG. 14) using a frequency band different from that of the first communication module 1311. The electronic device may include one or more processors (e.g., the processor 1320 of FIG. 13 or the processor 1920 of FIG. 19) operatively connected to the one or more wireless communication modules. The electronic device may include a memory (e.g., the memory 1330 of FIG. 13 or the memory 1930 of FIG. 19) electrically connected, directly or indirectly, to the one or more processors and configured to store instructions executable by the one or more processors. The instructions are executed individually and/or collectively, by the one or more processors 1320; 1920 to cause the electronic device 1301; 1901 to transmit and receive data to and from an external electronic device included in both a first NAN cluster and the electronic device through the first communication module. The instructions are executed individually and/or collectively, by the one or more processors 1320; 1920 to cause the electronic device 1301; 1901 to transmit the association information of the first NAN cluster to the external electronic device after terminating the operation of transmitting and receiving data, supported through the first communication module. The instructions are executed individually and/or collectively, by the one or more processors 1320; 1920 to cause the electronic device 1301; 1901 to hand off the association information of the first NAN cluster from the first communication module to the second communication module. The instructions are executed individually and/or collectively, by the one or more processors 1320; 1920 to cause the electronic device 1301; 1901 to form a second NAN cluster including the electronic device and the external electronic device based on the association information of the first NAN cluster through the second communication module.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the second communication module may support low-power communication by using a low frequency band compared to the first communication module 1311.

According to an embodiment, the association information of the first NAN cluster may include at least one of synchronization information of the first NAN cluster, NAN service information, or NAN data link schedule information.

According to an embodiment, the NAN data link schedule information may be transmitted by a NAN frame comprising a corresponding NAN availability attribute.

According to an embodiment, the first NAN cluster and the second NAN cluster may be synchronized based on the same TSF timer information. The first NAN cluster and the second NAN cluster may have different cluster IDs. The first NAN cluster and the second NAN cluster may be supported by different frequency bands.

According to an embodiment, the instructions are executed individually and/or collectively, by the one or more processors 1320; 1920 to cause the electronic device 1301; 1901 to maintain synchronization between the electronic device and the external electronic device included in the second NAN cluster, based on the NAN data link schedule that occupies a minimum and/or small time slot.

According to an embodiment, the instructions are executed individually and/or collectively, by the one or more processors 1320; 1920 to cause the electronic device 1301; 1901 to, in response to triggering a NAN service, determine at least one communication module and a data link schedule to support the NAN service. The operations may further include an operation of, based on the determined at least one communication module and the determined data link schedule, transmitting and receiving data to and from the external electronic device.

According to an embodiment, the instructions are executed individually and/or collectively, by the one or more processors 1320; 1920 to cause the electronic device 1301; 1901 to, if the determined at least one communication module comprises the first communication module, form a third NAN cluster supported by the first communication module, based on the association information of the second NAN cluster.

According to an embodiment, an electronic device (e.g., the electronic device 1301 of FIG. 13 or the electronic device 1901 of FIG. 19) may include one or more wireless communication modules (e.g., the wireless communication module 1310 of FIG. 13 or the wireless communication module 1992 of FIG. 19) including a first communication module (e.g., the first communication module 1311 of FIG. 14) supporting a NAN protocol and a second communication module (e.g., the second communication module 1312 of FIG. 14) supporting the HaLow protocol. The electronic device may include one or more processors (e.g., the processor 1320 of FIG. 13 or the processor 1920 of FIG. 19) operatively connected, directly or indirectly, to the one or more wireless communication modules. The electronic device may include a memory (e.g., the memory 1330 of FIG. 13 or the memory 1930 of FIG. 19) electrically connected, directly or indirectly, to the one or more processors and configured to store instructions executable by the one or more processors. The instructions are executed individually and/or collectively, by the one or more processors 1320; 1920 to cause the electronic device 1301; 1901 to transmit and receive data to and from an external electronic device included in both a NAN cluster and the electronic device through the first communication module. The instructions are executed individually and/or collectively, by the one or more processors 1320; 1920 to cause the electronic device 1301; 1901 to hand off the association information of the NAN cluster from the first communication module to the second communication module after terminating the operation of transmitting and receiving data, supported through the first communication module. The instructions are executed individually and/or collectively, by the one or more processors 1320; 1920 to cause the electronic device 1301; 1901 to transmit the association information of the NAN cluster and the association information of the HaLow protocol to the external electronic device through the second communication module. The instructions are executed individually and/or collectively, by the one or more processors 1320; 1920 to cause the electronic device 1301; 1901 to perform HaLow setup with the external electronic device, based on the association information of the HaLow protocol, through the second communication module. The instructions are executed individually and/or collectively, by the one or more processors 1320; 1920 to cause the electronic device 1301; 1901 to maintain the association information of the NAN cluster by transmitting a HaLow beacon including the association information of the NAN cluster to the external electronic device through the second communication module.

According to an embodiment, the association information of the NAN cluster may include at least one of synchronization information of the NAN cluster, NAN service information, or NAN data link schedule information. The association information of the HaLow protocol may include at least one of TWT parameters for a TWT service, information on a cycle of a HaLow beacon, and/or information on a TIM mode.

According to an embodiment, The instructions are executed individually and/or collectively, by the one or more processors 1320; 1920 to cause the electronic device 1301; 1901 to receive a signal corresponding to NAN service triggering from the external electronic device operating in a non-TIM mode. The instructions are executed individually and/or collectively, by the one or more processors 1320; 1920 to cause the electronic device 1301; 1901 to form a NAN cluster including the electronic device and the external electronic device based on the association information of the NAN cluster.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
one or more wireless communication modules comprising a first communication module, comprising communication circuitry, configured for supporting a neighbor awareness networking (NAN) protocol and a second communication module, comprising communication circuitry, configured for a different frequency band from that of the first communication module;
one or more processors, comprising processing circuitry, operatively connected to the one or more wireless communication modules; and
a memory configured to store instructions, wherein, the instructions are executed individually and/or collectively, by the one or more processors, to cause the electronic device to:
transmit and receive data to and from an external electronic device comprised in a NAN cluster and the electronic device through the first communication module;
transmit association information of the NAN cluster to the external electronic device after terminating the transmitting and receiving data supported through the first communication module;
hand off the association information of the NAN cluster from the first communication module to the second communication module; and
maintain the NAN cluster based on the association information of the NAN cluster through the second communication module.

2. The electronic device of claim 1, wherein
the second communication module is configured to
support low-power communication via a low frequency band compared to the first communication module.

3. The electronic device of claim 1, wherein the association information of the NAN cluster comprises:
at least one of synchronization information of the NAN cluster, NAN service information, or NAN data link schedule information.

4. The electronic device of claim 3, wherein
the NAN data link schedule information is configured to be transmitted by a NAN frame comprising a corresponding NAN availability attribute.

5. The electronic device of claim 1, wherein
a NAN cluster supported through the first communication module and a NAN cluster supported through the second communication module are synchronized based on the same time synchronization function (TSF) timer information and have the same cluster identifier (ID).

6. The electronic device of claim 1, wherein
a NAN cluster supported through the first communication module and a NAN cluster supported through the second communication module have different schedules for the same NAN data link and are supported with different frequency bands.

7. The electronic device of claim 1, wherein
the instructions are executed individually and/or collectively, by the one or more processors to cause the electronic device to:
reset a NAN data link schedule based on the association information of the NAN cluster; and
maintain synchronization between the electronic device and the external electronic device comprised in the NAN cluster at least by transmitting a NAN beacon frame, based on the reset NAN data link schedule,
wherein the reset NAN data link schedule comprises
a NAN data link schedule occupying a minimum and/or small time slot.

8. The electronic device of claim 1, wherein
the instructions are executed individually and/or collectively, by the one or more processors to cause the electronic device to:
in response to triggering a NAN service, determine at least one communication module and a data link schedule to support the NAN service; and,
based on the determined at least one communication module and the determined data link schedule, transmit and receive data to and from the external electronic device.

9. An electronic device comprising:
one or more wireless communication modules comprising a first communication module, comprising communication circuitry, configured for supporting a neighbor awareness networking (NAN) protocol, and a second communication module, comprising communication circuitry, configure for a different frequency band from that of the first communication module;
one or more processors, comprising processing circuitry, operatively connected to the one or more wireless communication modules; and
a memory configured to store instructions, wherein,
the instructions are executed individually and/or collectively by the one or more processors to cause the electronic device to:
transmit and receive data to and from an external electronic device comprised in a first NAN cluster through at least the first communication module;
transmit association information of the first NAN cluster to the external electronic device after terminating the transmitting and receiving data supported through the first communication module;
hand off the association information of the first NAN cluster from the first communication module to the second communication module; and
form a second NAN cluster comprising the electronic device and the external electronic device based on the association information of the first NAN cluster through at least the second communication module.

10. The electronic device of claim 9, wherein the first NAN cluster and the second NAN cluster:
are synchronized based on the same time synchronization function (TSF) timer information,
have different cluster identifiers (IDs), and
are supported with different frequency bands.

11. The electronic device of claim 9, wherein
the instructions are executed individually and/or collectively, by the one or more processors to cause the electronic device to:
maintain synchronization between the electronic device and the external electronic device comprised in the second NAN cluster based on a NAN data link schedule occupying a minimum and/or small time slot.

12. The electronic device of claim 9, wherein
the instructions are executed individually and/or collectively, by the one or more processors to cause the electronic device to:
in response to triggering a NAN service, determine at least one communication module and a data link schedule to support the NAN service;
based on the determined at least one communication module and the determined data link schedule, transmit and receive data to and from the external electronic device; and,
when the determined at least one communication module comprises the first communication module, form a third NAN cluster supported by the first communication module, based on the association information of the second NAN cluster.

13. An electronic device comprising:
one or more wireless communication modules comprising a first communication module, comprising communication circuitry, configured for supporting a neighbor awareness networking (NAN) protocol, and a second communication module, comprising communication circuitry, configured for supporting a high efficiency low power (HaLow) protocol;
one or more processors, comprising processing circuitry, operatively connected to the one or more wireless communication modules; and
a memory configured to store instructions, wherein,
the instructions are executed individually and/or collectively by the one or more processors to cause the electronic device to:
transmit and receive data to and from an external electronic device comprised in a NAN cluster through at least the first communication module;
hand off association information of the NAN cluster from the first communication module to the second communication module after terminating the transmitting and receiving data supported through the first communication module;
transmit the association information of the NAN cluster and association information of the HaLow protocol to the external electronic device through at least the second communication module;
perform HaLow setup with the external electronic device, based on the association information of the HaLow protocol, through at least the second communication module; and
maintain the association information of the NAN cluster at least by transmitting a HaLow beacon comprising the association information of the NAN cluster to the external electronic device through at least the second communication module.

14. The electronic device of claim 13, wherein
the association information of the NAN cluster comprises:
at least one of synchronization information of the NAN cluster, NAN service information, or NAN data link schedule information, and
the association information of the HaLow comprises:
at least one of target wake time (TWT) parameters for a TWT service, information on a cycle of the HaLow beacon, or information on a traffic indication map (TIM) mode.

15. The electronic device of claim 13, wherein
the instructions are executed individually and/or collectively, by the one or more processors to cause the electronic device to:
receive a signal corresponding to NAN service triggering from the external electronic device to be operating in a non-TIM mode; and
form a NAN cluster comprising the electronic device and the external electronic device, based on the association information of the NAN cluster.
